(19) United States
(12) Patent Application Publication
(10) Pub. No.: US 2024/0402899 A1
(43) Pub. Date: Dec. 5, 2024

(54) CONTROL USER INTERFACE ELEMENTS

(71) Applicant: Apple Inc., Cupertino, CA (US)

(72) Inventors: Dila SART, San Jose, CA (US); Alexander W. JOHNSTON, La Jolla, CA (US); Neil P. CORMICAN, Menlo Park, CA (US); Elbert D. CHEN, Cupertino, CA (US)

(21) Appl. No.: 18/732,094

(22) Filed: Jun. 3, 2024

Related U.S. Application Data
(60) Provisional application No. 63/506,114, filed on Jun. 4, 2023.

(51) Int. Cl. G06F 3/0485; G06F 3/0482

(52) U.S. Cl. CPC G06F 3/0485; G06F 3/0482

(57) ABSTRACT

Some embodiments described in this disclosure are directed to one or more electronic devices that present a scrollable user interface concurrently with a control user interface element. Some embodiments described in this disclosure are directed to one or more electronic devices configured to present user interfaces associated with information included in the control user interface element.

### CROSS-REFERENCE TO RELATED APPLICATIONS

This application claims the benefit of U.S. Provisional Application No. 63/506,114, filed Jun. 4, 2023, the entire disclosure of which is herein incorporated by reference for all purposes.

### FIELD OF THE DISCLOSURE

This relates generally to user interfaces that present information and one or more controls for interacting with applications and media content on an electronic device.

### BACKGROUND

User interaction with electronic devices has increased significantly in recent years. These devices can be devices such as computers, tablet computers, televisions, multimedia devices, mobile devices, and the like.

In some circumstances, such a device presents a user interface that can be navigated. In some circumstances, the electronic device additionally presents user interface elements that are not necessarily associated with the user interface. In some circumstances, users wish to navigate the user interface and interact with the user interface elements efficiently. Enhancing these interactions improves the user's experience with the device and decreases user interaction time, which is particularly important where input devices are battery-operated.

### SUMMARY

Some embodiments described in this disclosure are directed to one or more electronic devices that present a scrollable user interface concurrently with a control user interface element. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIGS. 5A-5C illustrate block diagrams of exemplary architectures for devices according to some embodiments of the disclosure.

FIGS. 6A-6R illustrate exemplary ways in which an electronic device facilitates display of a control user interface element overlaid over respective user interfaces in accordance with some embodiments of the disclosure.

FIG. 7 is a flow diagram illustrating a method of facilitating display of a control user interface element overlaid over respective user interfaces in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods for presenting a control user interface concurrently with respective user interfaces. In some embodiments, the electronic device displays a scrollable user interface. In some embodiments, while displaying the scrollable user interface the electronic device detects input including a request to navigate the scrollable user interface. In some embodiments, in response to receiving the input, the electronic device displays a control user interface element in accordance with a determination that a current scrolling position relative to the scrollable user interface is within a first range of positions. Such techniques can reduce the cognitive burden on a user who uses such devices. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

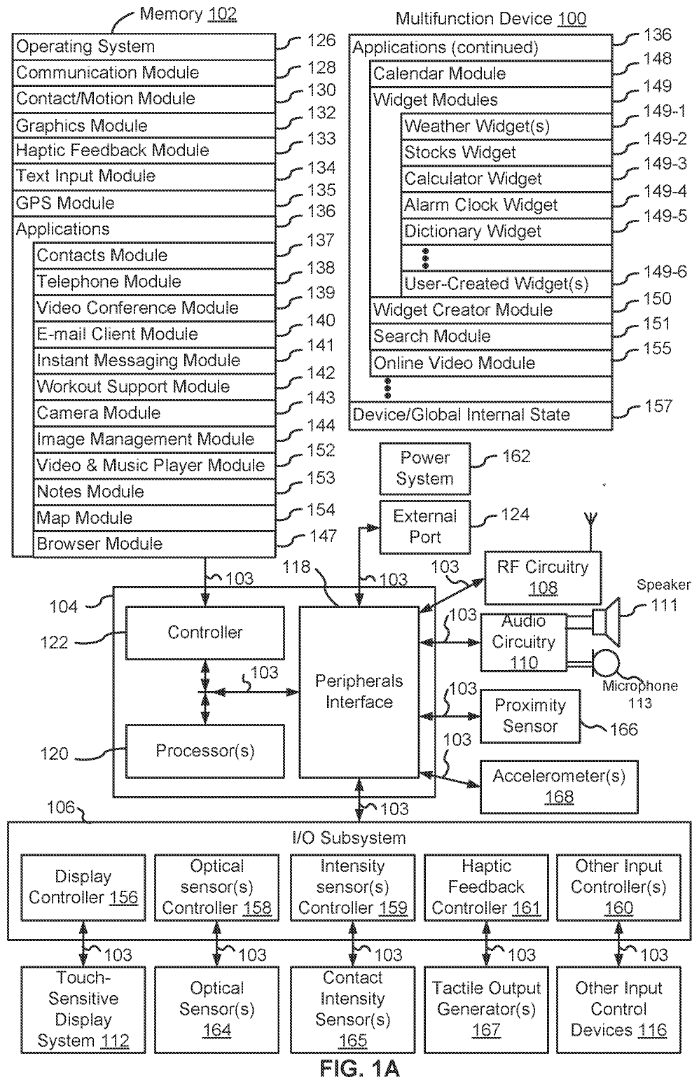

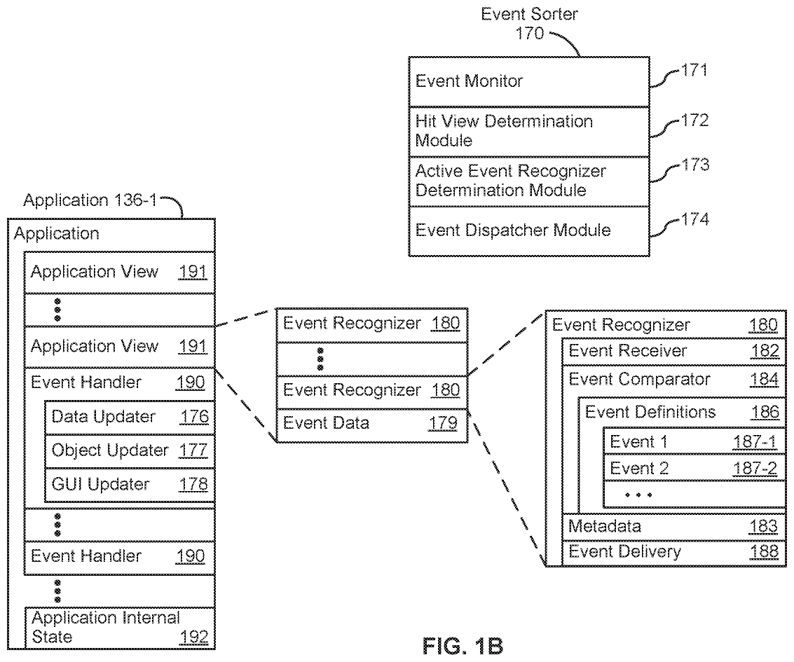

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

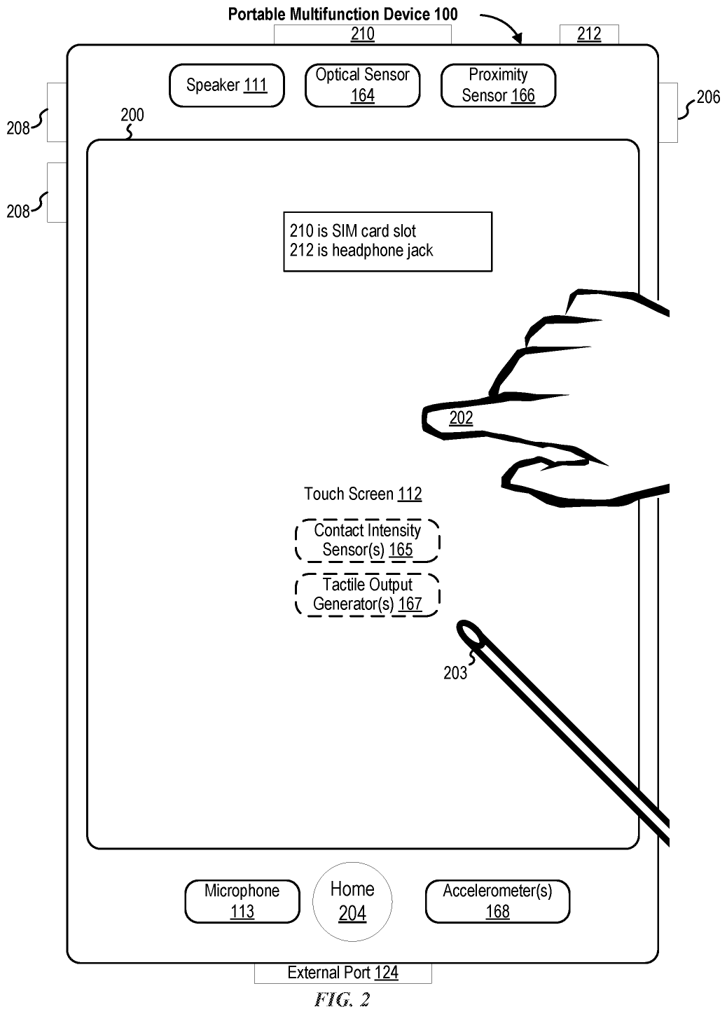

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's car (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

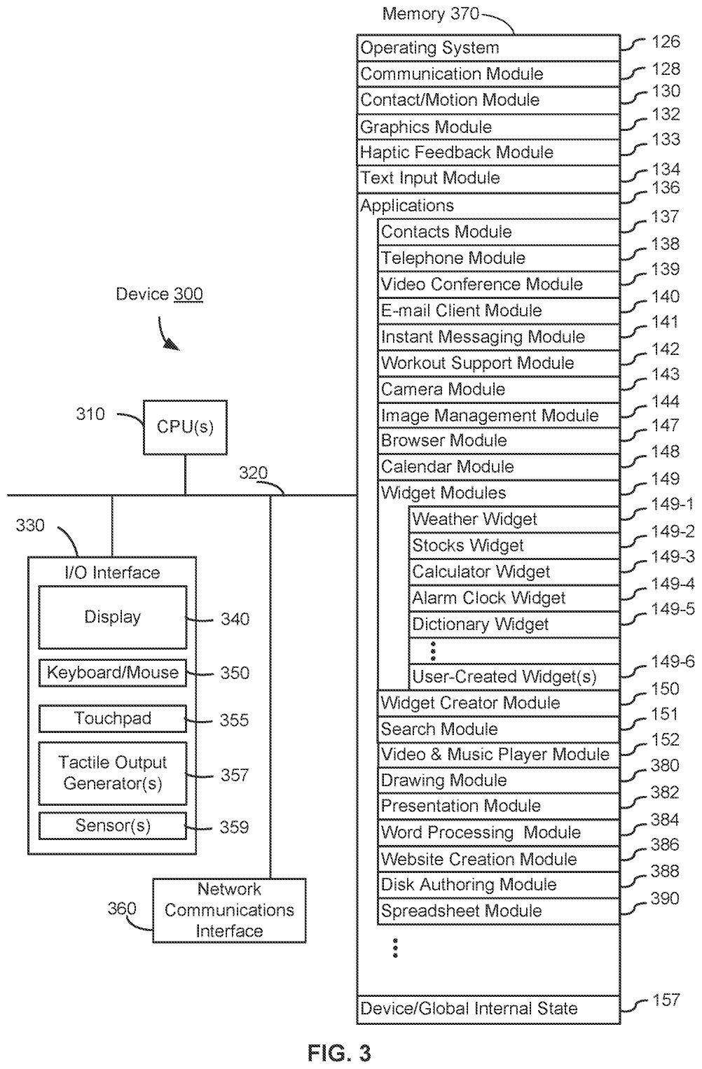

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

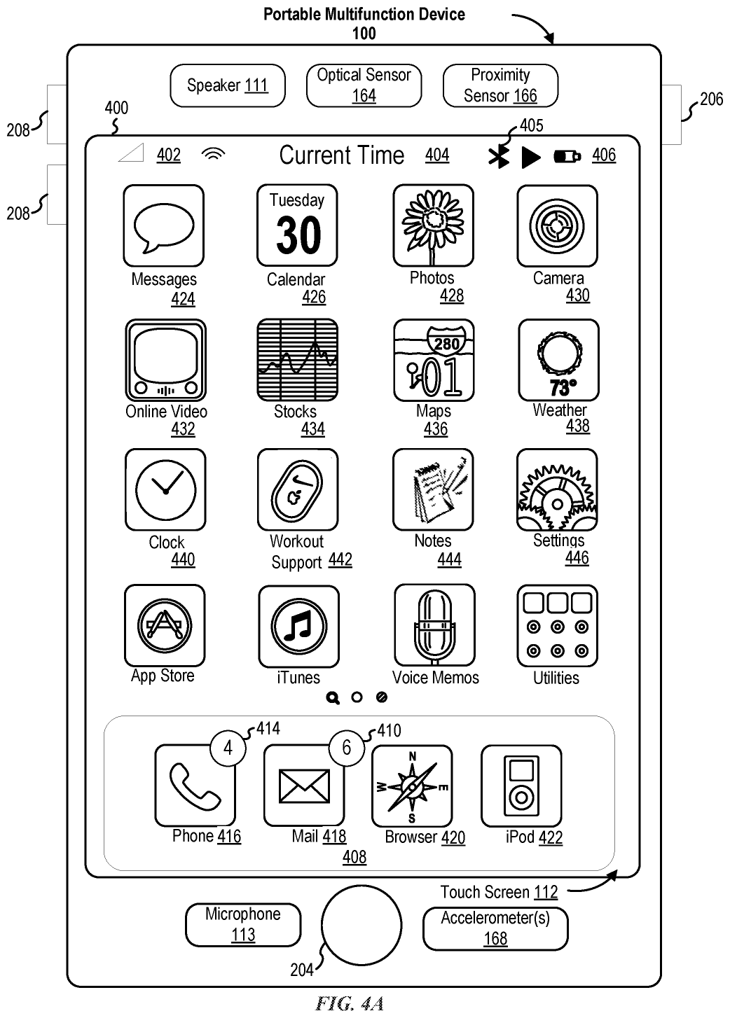

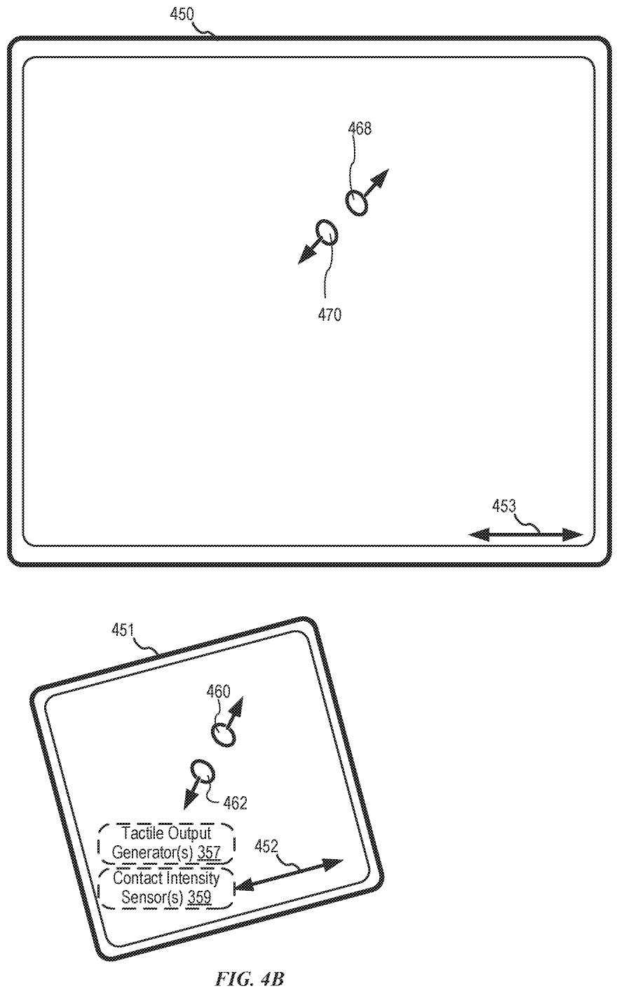

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

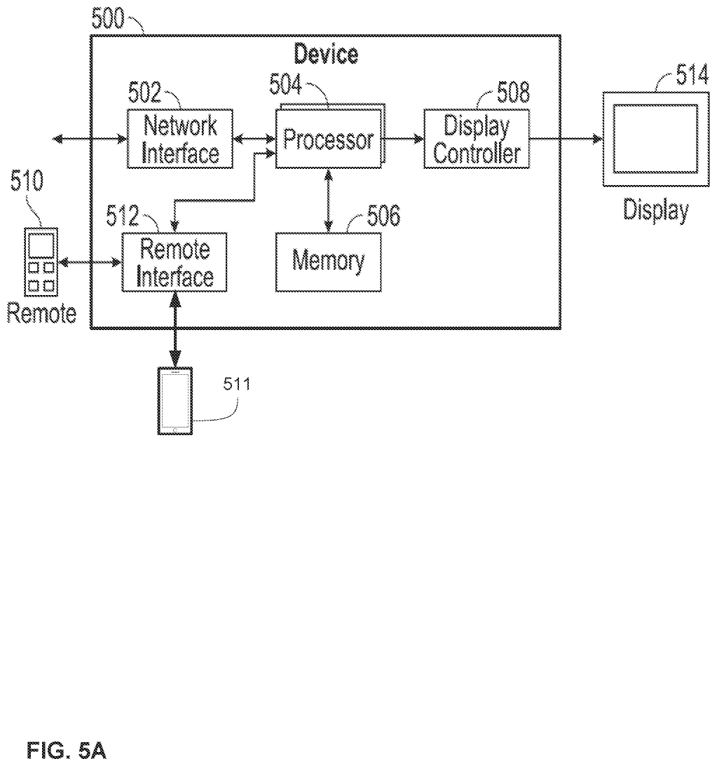

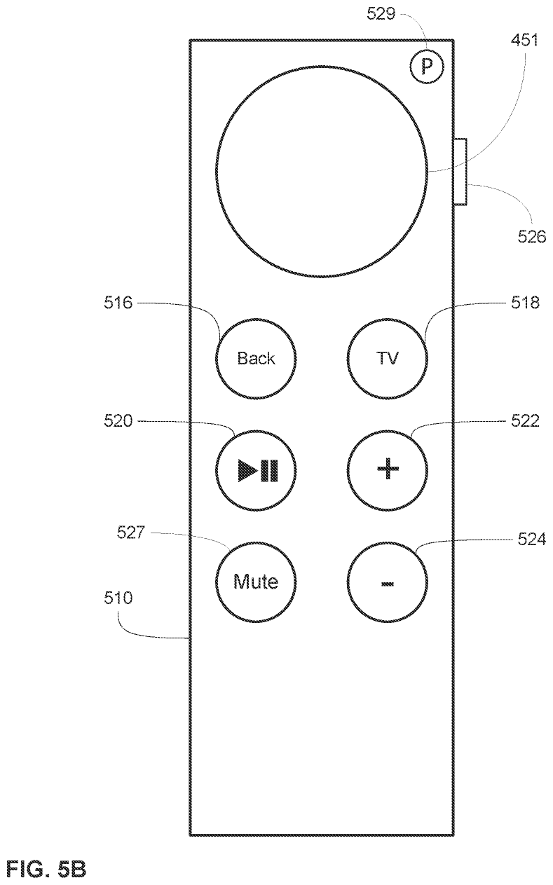

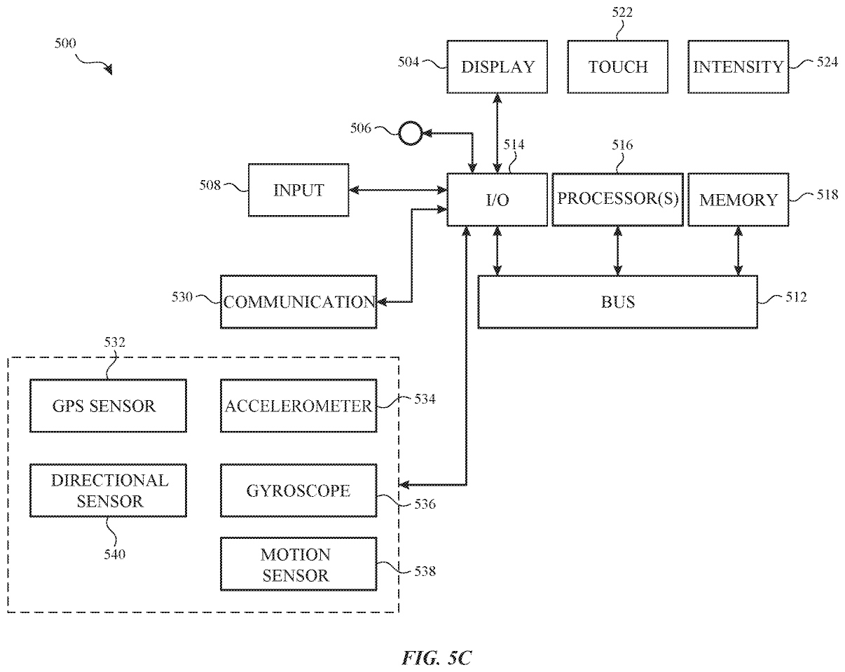

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., method 700).

In some embodiments, display controller 508 causes the various user interfaces of the disclosure to be displayed on display 514. Further, input to device 500 is optionally provided by remote 510 via remote interface 512, which is optionally a wireless or a wired connection. In some embodiments, input to device 500 is provided by a multifunction device 511 (e.g., a smartphone) on which a remote control application is running that configures the multifunction device to simulate remote control functionality, as will be described in more detail below. In some embodiments, multifunction device 511 corresponds to one or more of device 100 in FIGS. 1A and 2, and device 300 in FIG. 3. It is understood that the embodiment of FIG. 5A is not meant to limit the features of the device of the disclosure, and that other components to facilitate other features described in the disclosure are optionally included in the architecture of FIG. 5A as well. In some embodiments, device 500 optionally corresponds to one or more of multifunction device 100 in FIGS. 1A and 2 and device 300 in FIG. 3; network interface 502 optionally corresponds to one or more of RF circuitry 108, external port 124, and peripherals interface 118 in FIGS. 1A and 2, and network communications interface 360 in FIG. 3; processor 504 optionally corresponds to one or more of processor(s) 120 in FIG. 1A and CPU(s) 310 in FIG. 3; display controller 508 optionally corresponds to one or more of display controller 156 in FIG. 1A and I/O interface 330 in FIG. 3; memory 506 optionally corresponds to one or more of memory 102 in FIG. 1A and memory 370 in FIG. 3; remote interface 512 optionally corresponds to one or more of peripherals interface 118, and I/O subsystem 106 (and/or its components) in FIG. 1A, and I/O interface 330 in FIG. 3; remote 512 optionally corresponds to and or includes one or more of speaker 111, touch-sensitive display system 112, microphone 113, optical sensor(s) 164, contact intensity sensor(s) 165, tactile output generator(s) 167, other input control devices 116, accelerometer(s) 168, proximity sensor 166, and I/O subsystem 106 in FIG. 1A, and keyboard/mouse 350, touchpad 355, tactile output generator(s) 357, and contact intensity sensor(s) 359 in FIG. 3, and touch-sensitive surface 451 in FIG. 4B; and, display 514 optionally corresponds to one or more of touch-sensitive display system 112 in FIGS. 1A and 2, and display 340 in FIG. 3.

FIG. 5B illustrates an exemplary structure for remote 510 according to some embodiments of the disclosure. In some embodiments, remote 510 optionally corresponds to one or more of multifunction device 100 in FIGS. 1A and 2 and device 300 in FIG. 3. Remote 510 optionally includes touch-sensitive surface 451. Touch-sensitive surface 451 is optionally able to sense contacts as well as contact intensities (e.g., clicks of touch-sensitive surface 451), as previously described in this disclosure. Further, touch-sensitive surface 451 optionally includes a mechanical actuator for providing physical button click functionality (e.g., touch-sensitive surface 451 is “clickable” to provide corresponding input to device 500). Remote 510 also optionally includes buttons 516, 518, 520, 522, 524, 526, 527 and 529. Buttons 516, 518, 520, 522, 524, 526, 527 and 529 are optionally mechanical buttons or mechanical button alternatives that are able to sense contact with, or depression of, such buttons to initiate corresponding action(s) on, for example, device 500. In some embodiments, selection of “back” button 516 by a user navigates device 500 backwards in a currently-executing application or currently-displayed user interface (e.g., back to a user interface that was displayed previous to the currently-displayed user interface), or navigates device 500 to a one-higher-level user interface than the currently-displayed user interface. In some embodiments, selection of “TV” button 518 by a user navigates device 500 to a main, home, media browsing user interface or root user interface from any user interface that is displayed on device 500 (e.g., to a home screen of device 500 that optionally includes one or more applications accessible on device 500 or to a media browsing user interface of device 500 that includes representations of media available for viewing via device 500). In some embodiments, selection of the “TV” button 518 causes the electronic device to navigate to a unified media browsing application. In some embodiments, selection of “play/pause” button 520 by a user toggles between playing and pausing a currently-playing content item on device 500 (e.g., if a content item is playing on device 500 when “play/pause” button 520 is selected, the content item is optionally paused, and if a content item is paused on device 500 when “play/pause” button 520 is selected, the content item is optionally played). In some embodiments, selection of “+” 522 or “−” 524 buttons by a user increases or decreases, respectively, the volume of audio reproduced by device 500 (e.g., the volume of a content item currently-playing on device 500). In some embodiments, selection of “audio input” button 526 (e.g., which is optionally a button on the side surface of remote 510, rather than on the surface of remote 510 that includes buttons 516, 518, 520, 522, 524 and 527) by a user allows the user to provide audio input (e.g., voice input) to device 500, optionally, to a voice assistant on the device. In some embodiments, remote 510 includes a microphone via which the user provides audio input to device 500 upon selection of “audio input” button 526. In some embodiments, remote 510 includes one or more accelerometers for detecting information about the motion of the remote. In some embodiments, selection of “Mute” button 527 toggles the audio reproduced by device 500 on and off. In some embodiments, selection of “Power” button 529 causes device 500 (and/or external devices coupled to device 500, such as display 514) to toggle between entering or exiting a low or off power state.

FIG. 5C depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

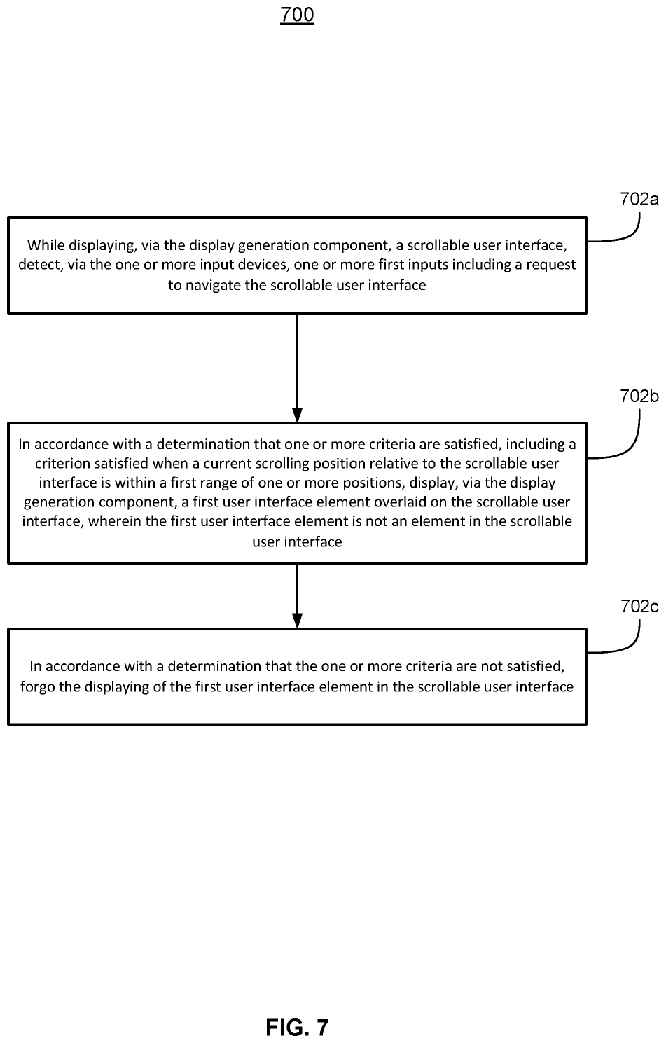

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes described with reference to FIGS. 7 and 9. A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5C, but can include other or additional components in multiple configurations.

In some embodiments, electronic device 500 includes one or more tactile output generators, where the one or more tactile output generators generate different types of tactile output sequences, as described below in Table 1. In some embodiments, a particular type of tactile output sequence generated by the one or more tactile output generators of the device corresponds to a particular tactile output pattern. For example, a tactile output pattern specifies characteristics of a tactile output, such as the amplitude of the tactile output, the shape of a movement waveform of the tactile output, the frequency of the tactile output, and/or the duration of the tactile output. When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

One or more of the embodiments disclosed herein optionally include one or more of the features disclosed in the following patent applications: “User Interfaces For Interacting with Channels that Provide Content that Plays in a Media Browsing Application” (Attorney Docket No.: 106843171600 (P42089USP1), filed Mar. 24, 2019), “User Interfaces For a Media Browsing Application” (Attorney Docket No.: 106843171700 (P42090USP1), filed Mar. 24, 2019), and “User Interface Specific to Respective Content Items” (Attorney Docket No.: 106843171900 (P42092USP1), filed Mar. 24, 2019), each of which is hereby incorporated by reference.

Attention is now directed towards embodiments of user interfaces (“UI”) and associated processes that are implemented on an electronic device, such as portable multifunction device 100, device 300, or device 500.

### USER INTERFACES AND ASSOCIATED PROCESSES

### Control User Interface Elements and Scrollable User Interfaces

Users interact with electronic devices in many different manners, including using an electronic device to navigate user interfaces and interact with control user interface elements. In some embodiments, the electronic device displays a scrollable user interface. In some embodiments, while displaying the scrollable user interface the electronic device detects input including a request to navigate the scrollable user interface. In some embodiments, in response to receiving the input, the electronic device displays a control user interface element in accordance with a determination that a current scrolling position relative to the scrollable user interface is within a first range of positions. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

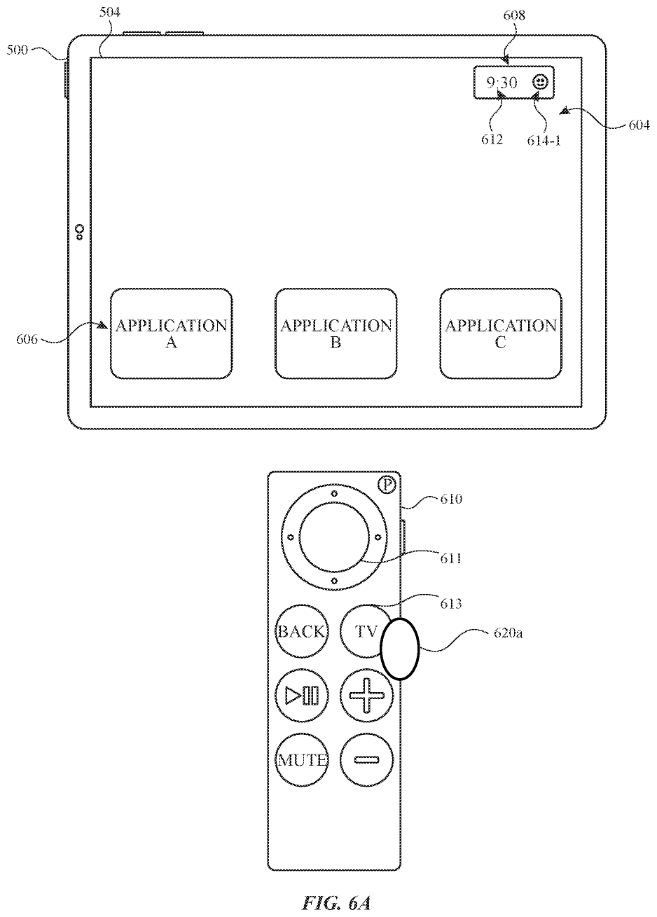

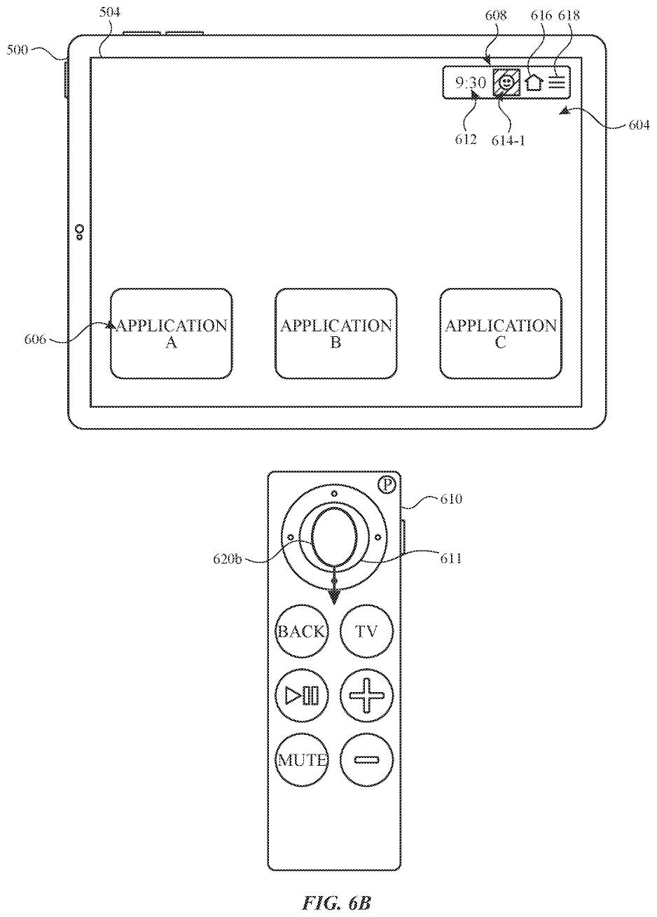

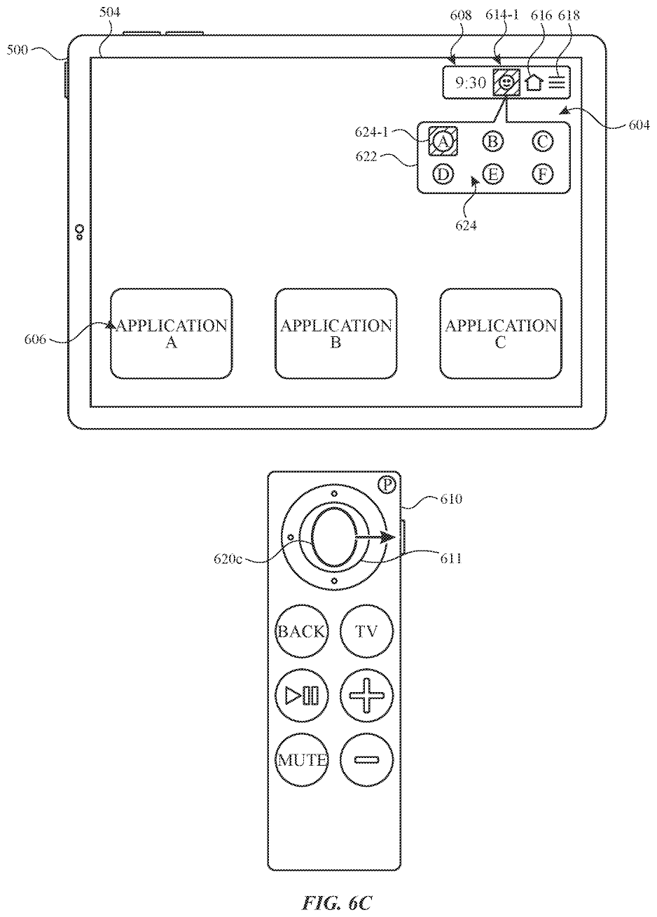

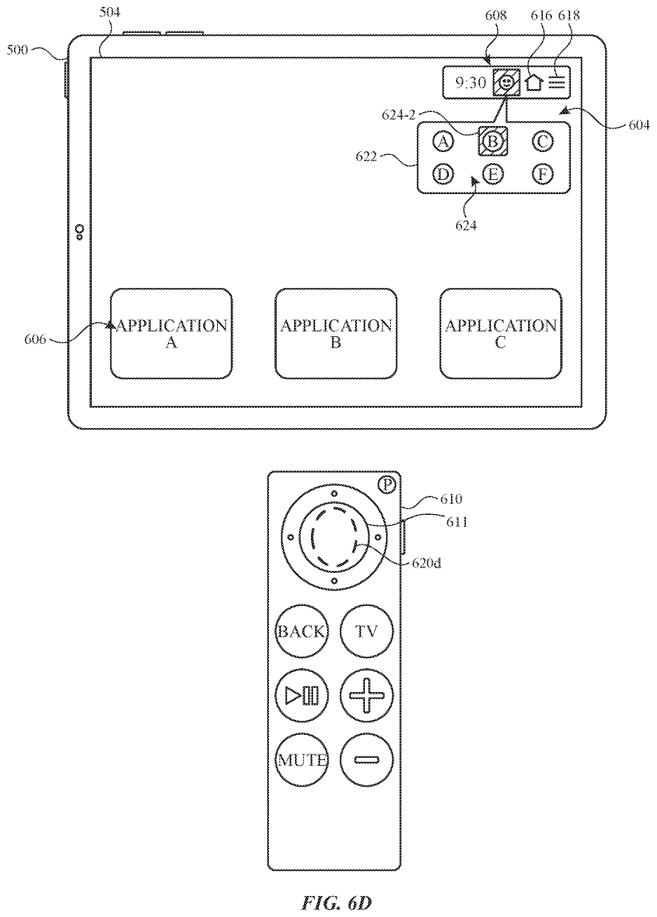

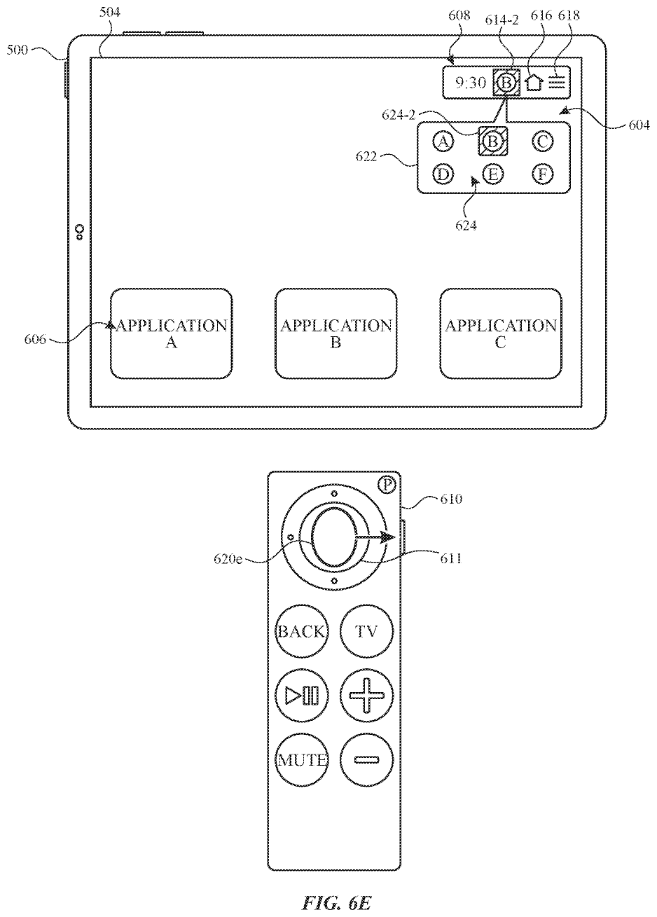

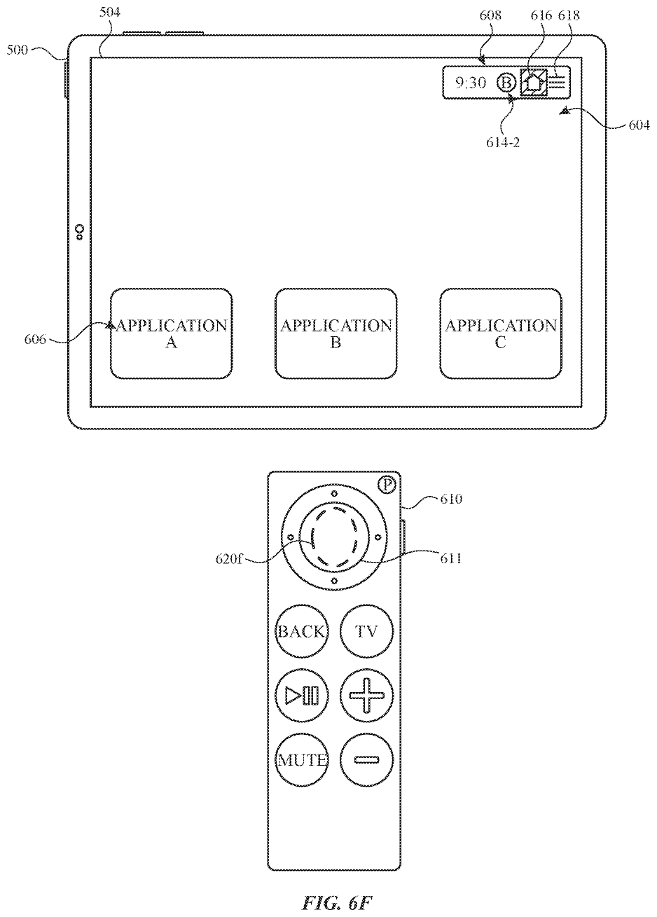

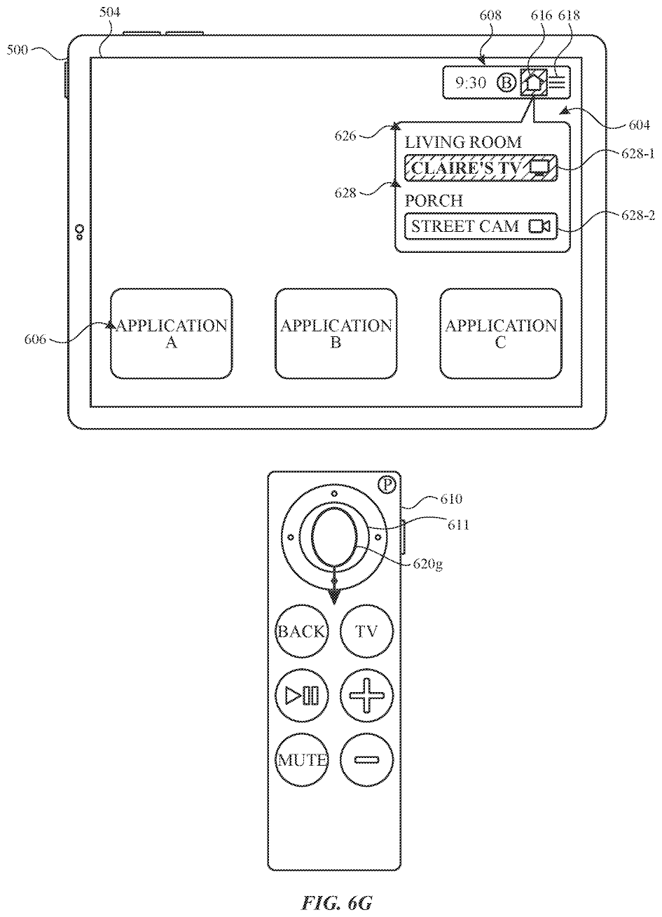

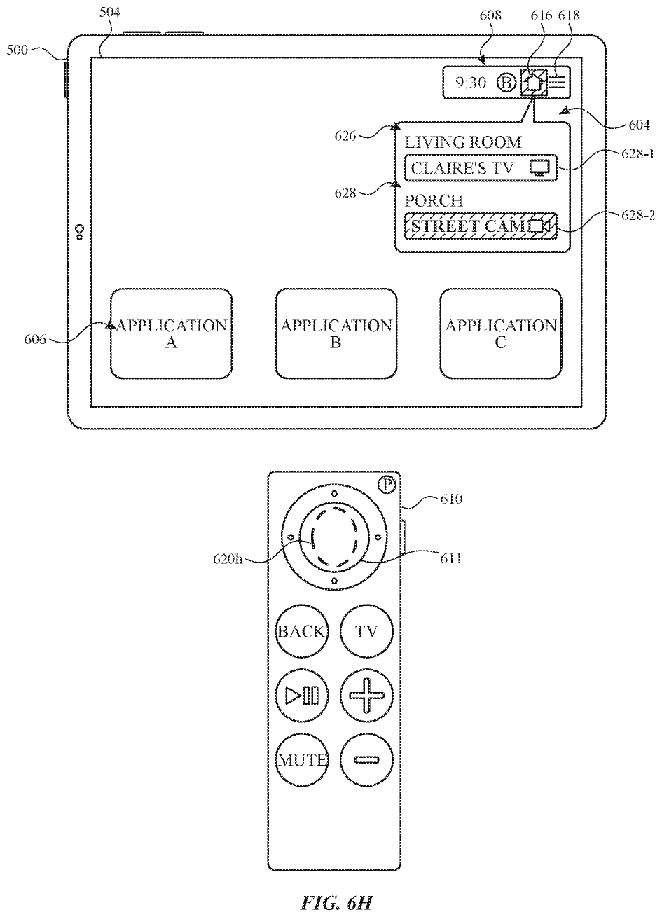

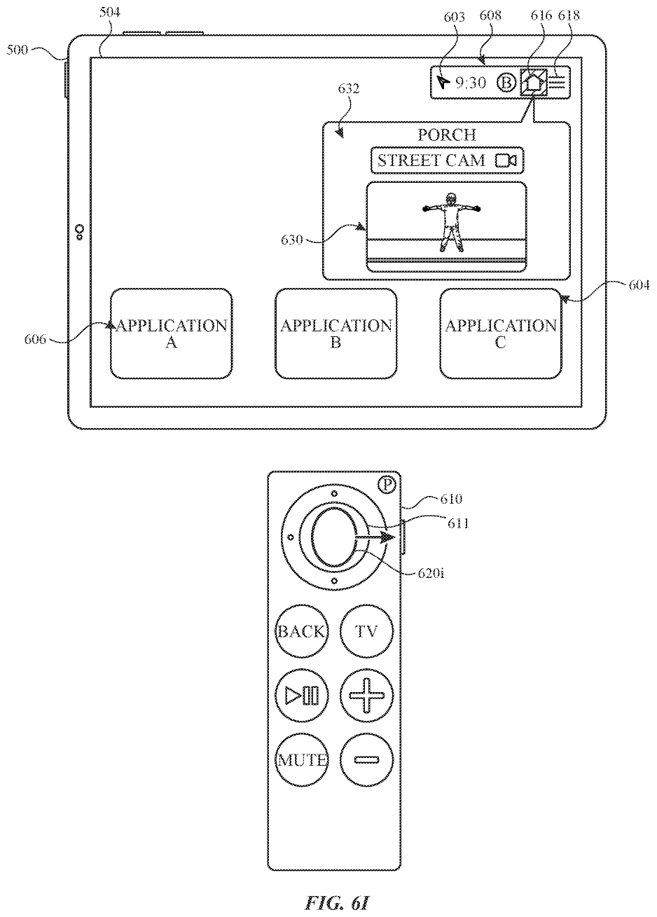

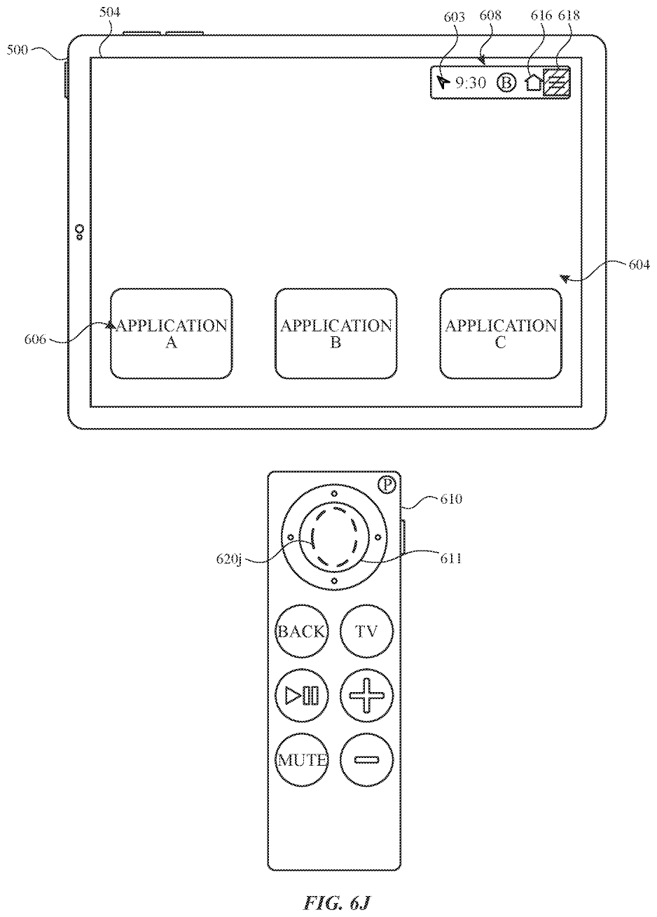

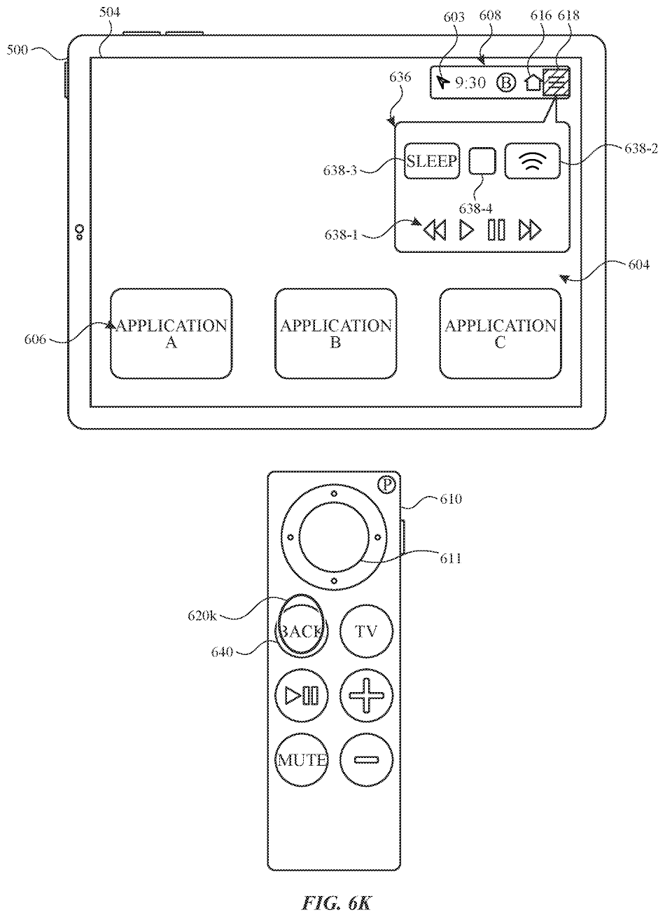

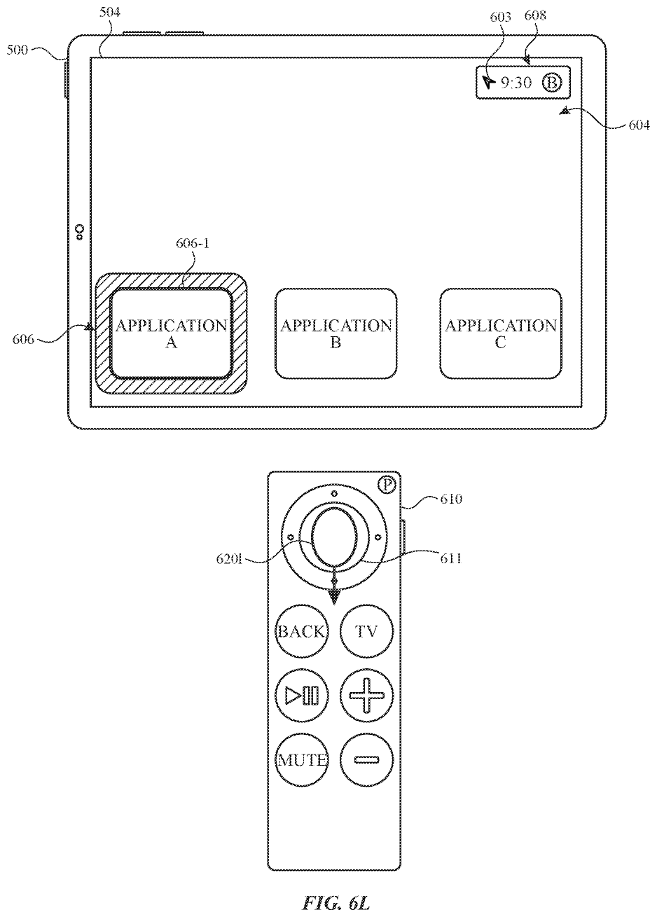

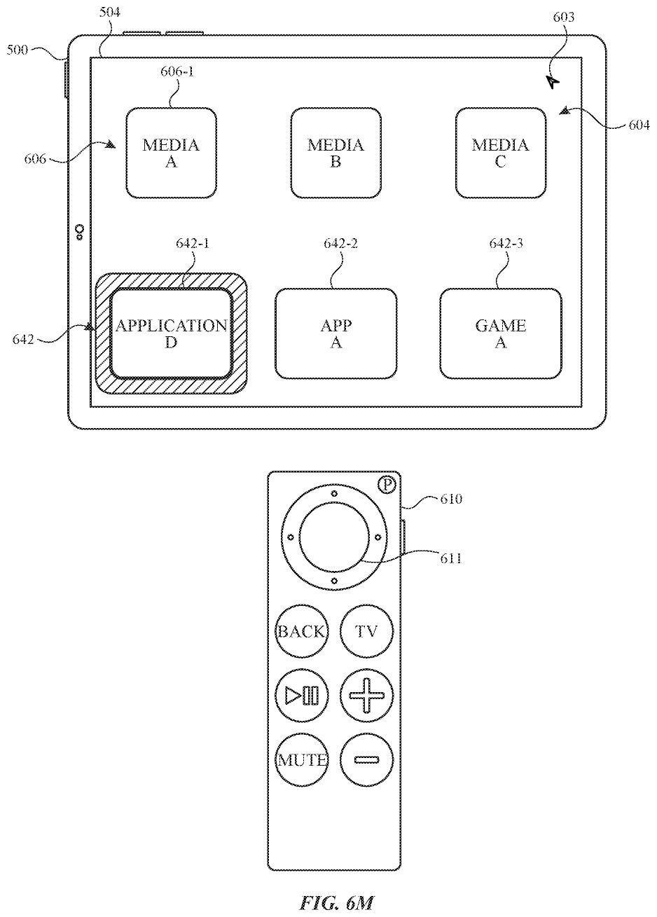

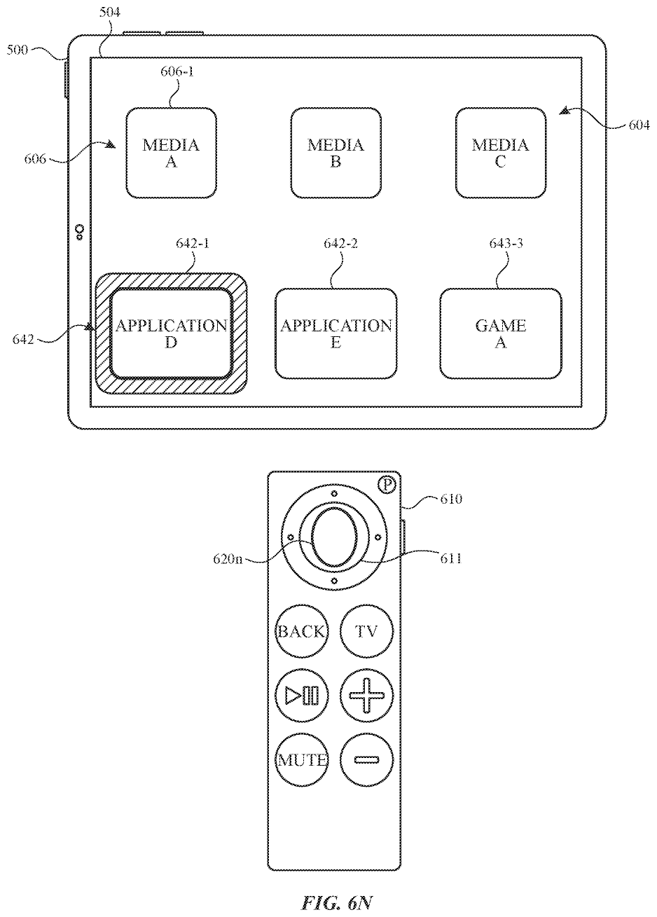

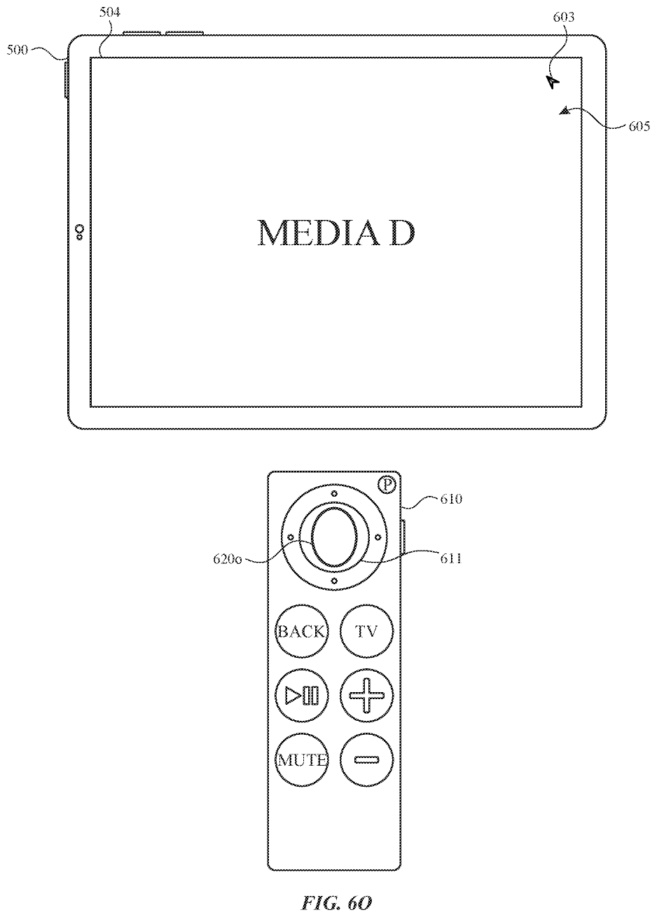

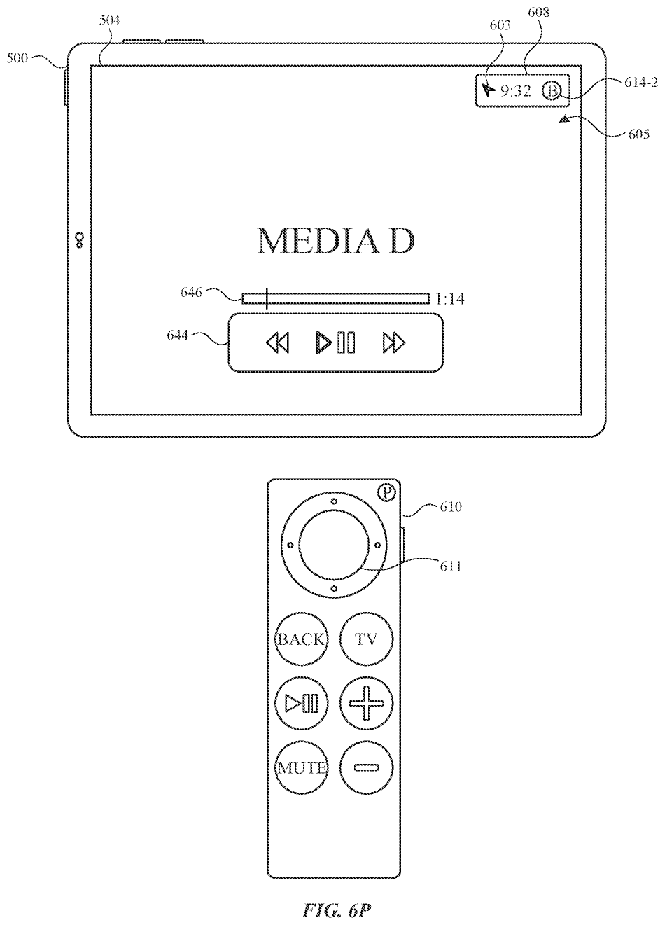

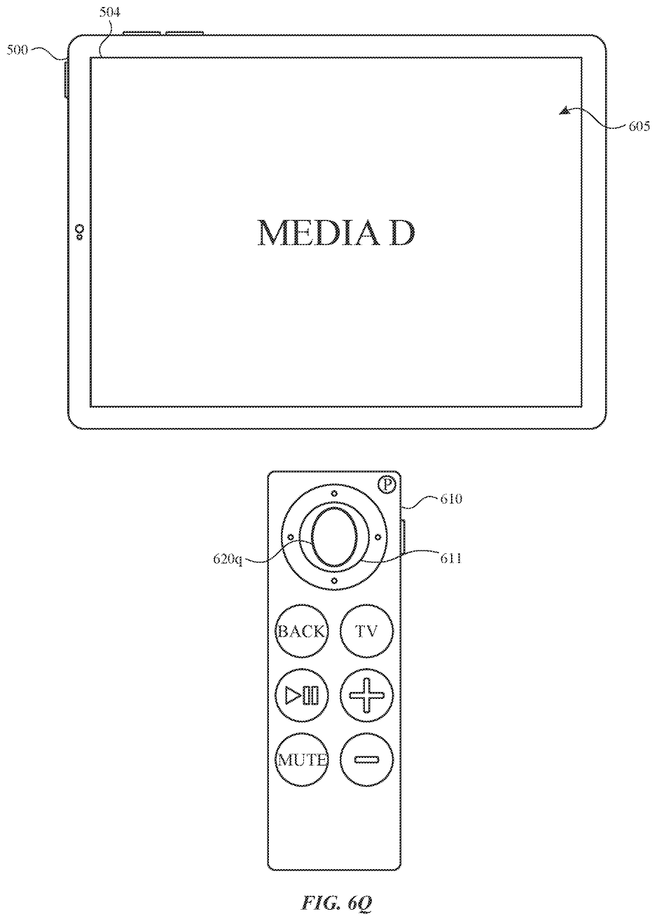

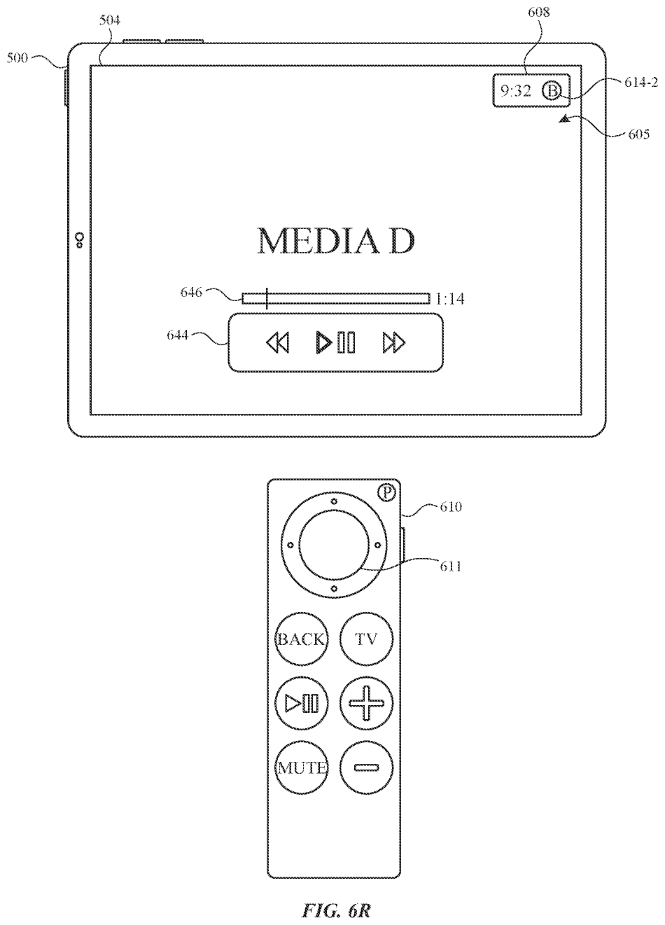

FIGS. 6A-6R illustrate exemplary ways in which an electronic device facilitates display of a control user interface element overlaid over respective user interfaces in accordance with some embodiments of the disclosure. The embodiments in these figures are used to illustrate the processes described below, including the processes described with reference to FIG. 7.

FIGS. 6A-6R illustrate exemplary ways in which an electronic device presents a visual element including information and selectable options to cause display of user interfaces.

FIG. 6A illustrates an electronic device 500, including a display 504, configured to present a user interface 604. It is understood that as described further with reference to method 700, electronic device 500 optionally corresponds to a media set top box or digital media player, in wireless or wired communication with display 504, which optionally corresponds to a television, monitor, and/or a projection device configured to cast images onto a surface in a physical environment of the user of electronic device 500.

In some embodiments, electronic device 500 optionally presents one or more user interfaces, such as user interface 604. In some embodiments—as described further with reference to method 700—user interface 604 is a “scrollable” user interface. For example, in response to detecting user input requesting navigation throughout the scrollable user interface, electronic device 500 optionally updates a navigation position relative to user interface 604, including a current scrolling position, and displays content corresponding to the current scrolling position. For example, user interface 604 includes representations 606, optionally corresponding to respective content (e.g., applications, folders including applications, device setting user interfaces, and/or user interface for performing operations associated with the electronic device), the representations respectively selectable to initiate presentation of user interfaces for interacting with the respective content. As illustrated in FIG. 6B, electronic device 500 optionally detects one or more inputs to change a position of focus of user input, optionally requesting navigation to a position that requires a change in the scrolling position. In response to such one or more inputs, electronic device 500 optionally updates user interface 604 to include content corresponding to the updated scrolling position (e.g., optionally ceasing display of representations 606, and/or optionally displaying additional representations of content).

In some embodiments, in accordance with a determination that a current scrolling position satisfies one or more criteria, electronic device 500 displays a visual element providing information associated with electronic device 500. For example, in FIG. 6A, the current scrolling position relative to user interface 604 is within a first range of positions (e.g., toward a top scrolling position of the user interface 604). Accordingly, electronic device 500 optionally displays visual element 608. In some embodiments, visual element 608 includes information 612 such as a time of day, a day of the week, and/or a date. In some embodiments, visual element 608 includes one or more selectable options, such as icon 614-1, that, when selected, cause the electronic device 500 to initiate display of respective information and/or user interfaces associated with the selected, selectable option. In some embodiments, the navigation inputs and/or selection inputs described previously are detected by electronic device 500. In some embodiments, such inputs are detected via one or more input devices, such as remote 610. It is understood that remote 610 has characteristics described with respect to devices illustrated in FIGS. 1-5, such as remote 510. In some embodiments, trackpad 611 included in remote 610 has one or more characteristics of touch-sensitive surface 451.

Electronic device 500 is optionally in wired or wireless communication with remote 610, corresponding to a hardware control input device that is configured to detect user input such as input directed to a directional pad (“d-pad”), a touch-sensitive surface such as trackpad 611 in FIG. 6A, one or more physical or virtual buttons such as button 613, switches, and/or electromechanical control circuitry such as an electromechanical crown. In some embodiments, remote 610 detects user input, and communicates information corresponding to and identifying the user input to electronic device 500. In response to receiving the information, electronic device 500 optionally performs one or more operations in accordance with the information. For example, in response to detecting a selection input directed to remote 610, electronic device 500 optionally selects a currently focused visual element included in user interface 604. In FIG. 6A, remote 610 detects an input including contact 620a directed to, and selecting button 613a, and optionally communicates an indication of the selection to electronic device 500. In some embodiments, the input includes detecting the contact 620a for at least a predetermined time threshold as described with reference to method 700. In response to detecting such the input including contact 620a for at least the predetermined time threshold, electronic device 500 optionally changes a focus of user input to target the user interface element 608.

Although embodiments described herein refer to contact (e.g., contact 620a) of the user with remote 610 (e.g., with buttons such as button 613, and/or with a touch-sensitive trackpad 611) as representative of user input detected by remote 610, it is understood that movement of contact 620a is merely one among many contemplated embodiments. For example, movement of focus and/or selection of elements of such user interfaces optionally are performed in response to detecting additional or alternative modalities of input directed to remote 610 and/or electronic device 500, such as a detecting a selection of a directional button from a d-pad, a voice command, an air gesture including movement of one or more portions of the user's body (e.g., an air pinch including a contacting of two fingers of a hand of the user, an air pointing including a pointing of one or more fingers of the user, and/or an air splaying including separation of one or more fingers), a rotation of a contact across a capacitive wheel, and/or movement and/or contact directed at a peripheral device (e.g., a mouse or stylus) moving a cursor. It is understood that description of embodiments related to inputs including contact with a trackpad, such as contact 620a, are merely exemplary and not disparaging of alternative modalities of input. Further, it is understood that contact with a trackpad is not a strictly preferred embodiment—contact with a trackpad is merely one of many possible embodiments. Some embodiments of the disclosure are directed to input detected by remote 610. It is understood that in some embodiments, the electronic device 500 detects such inputs via circuitry included in electronic device 500, and in some embodiments, the electronic device 500 performs operations in response to detecting information indicative of such inputs, such as information communicated from an input device such as the remote 610.

In some embodiments, in accordance with a determination that a selection input satisfies one or more criteria, including a criterion satisfied when the selection input is directed to specific circuitry included in remote 610 such as button 613, and/or including a criterion satisfied when the one or more characteristics of the selection input satisfy one or more second criteria (e.g., a criterion satisfied based on a force of the input, a duration of the input, and/or a sequence of multiple inputs), electronic device 500 performs one or more operations associated with visual element 608.

In FIG. 6B, electronic device 500 displays an indication of focus of user input—at times referred to herein as “focus”—directed to a portion of visual element 608 in response to contact 620a detected in FIG. 6A. For example, icon 614-1 is surrounded by a color, a fill pattern, and/or a border to provide visual emphasis and indicate that subsequent user input will be directed to icon 614-1, rather than another selectable option or to user interface 604. In some embodiments, in response to detecting user focus change to the visual element 608, computer system 101 optionally changes the content included in visual element 608. For example, electronic device 500 displays visual element 608 with an expanded size in accordance with a determination that focus is directed to icon 614-1, and optionally displays additional selectable options and/or information, such as icon 616 and icon 618. In some embodiments, independent of a target of focus, electronic device 500 displays information 612 in accordance with a determination that visual element 608 is displayed. In some embodiments, in response to detecting focus move to visual element 608, and/or within visual element 608, electronic device 500 maintains display of user interface 604, without scrolling user interface 604. In FIG. 6B, remote 610 detects navigation input including movement of contact 620b, such as a downward movement of an object such as a finger contacting a trackpad 611 included in remote 610. In response to receiving the input, electronic device 500 displays a user interface associated with the focused icon 614-1, as shown in FIG. 6B.

In FIG. 6C, electronic device 500 displays user interface 622 in response to detecting movement of contact 620b in FIG. 6B. In some embodiments, in response to detecting contact 620a in FIG. 6A, electronic device 500 proceeds to display user interface 622, without requiring detection of the movement of contact 620b in FIG. 6B. In some embodiments, user interface 622 includes a plurality of representations 624 associated with a plurality of user accounts that are available for selection, causing electronic device 500 to use a user account corresponding to the selected representation as an active user account (e.g., a user account that is currently logged into the electronic device 500). For example, the icon 614-1 in FIG. 6C indicates that a respective user account is currently active, different from a user account corresponding to a respective user account represented by representations 624. In FIG. 6C, electronic device 500 displays representations 624, including a focused, first representation 624-1 corresponding to a first user account. In some embodiments, the user accounts corresponding to representations 624 are currently logged in, and are respectively selectable to change the currently active user account. In some embodiments, the user accounts are at not logged in and/or have not been used for a period of time, and in response to detecting selection of a respective representation, electronic device 500 initiates a process to prompt the user to log in including prompting the user for identification and/or credentials associated with the selected representation. In some embodiments, representations 624 additionally or alternatively include a representation that, when selected, causes the electronic device to add a new user account, including initiating a logging in process in order to enroll a new user account with electronic device 500. In response to detecting a successful login (e.g., electronic mailing address, identifier, name, passwords, biological identifying information such as a fingerprint and/or facial scan data, and/or an indication of such information provided by another device such as a mobile device that corresponds to the credentials of the newly registered account), electronic device 500 optionally displays an additional representation corresponding to the newly registered user account included in representations 624. In FIG. 6C, remote 620 detects movement of contact 620c, and in response moves the focus within user interface 622, without scrolling user interface 604, as shown in FIG. 6D.

In FIG. 6D, in response to detecting contact 620c in FIG. 6C, electronic device 500 displays the indication of focus directed to a second representation 624-2 of representations 624. Remote 610 detects a selection input (e.g., a pressing of a button, a tap, a double-tap, a multi-contact tap, a pressing of a trackpad for a time less than a threshold period of time (e.g., 0.01, 0.05, 0.1, 0.5, or 1 s)) directed to trackpad 611 included in remote 610. In some embodiments, in response to receiving the input, electronic device 500 switches the active user account to correspond to a user account associated with the selected, second representation 624-2 and updates the user interface as shown in FIG. 6E. In some embodiments, the selection input is directed to a different set of circuitry than contact 620a (e.g., corresponding to a request to shift user focus to user interface element 608), such as directed to different buttons included in remote 610 and/or directed to different types of circuitry (e.g., to a button versus to a trackpad).

In FIG. 6E, the electronic device 500 updates user interface element 608 to include icon 614-2, indicating the active user account (e.g., user account “B”) in response to receiving the input in FIG. 6D. Electronic device 500 additionally maintains display of user interface 604 at its current scrolling position, and/or optionally maintains display of user interface 622. In some embodiments, in response to contact 620d, electronic device 500 ceases display of user interface 622. In FIG. 6E, remote 610 detects input including movement of contact 620e requesting movement of focus away from user interface 622 and/or icon 614-2.

In FIG. 6F, electronic device 500 changes focus to correspond to icon 616 included in user interface element 608, optionally while maintaining the current scrolling position of user interface 604 in response to receiving the input in FIG. 6E. In FIG. 6F, remote 610 detects a selection input with contact 620f, and in response to receiving the input, electronic device 500 displays an associated user interface, as shown in FIG. 6G. In some embodiments, in response to detecting movement of the contact 620e in FIG. 6E, electronic device 500 displays the user interfaces illustrated in FIG. 6G, without requiring detecting contact 620f.

In FIG. 6G, electronic device 500 displays user interface 626 corresponding to a user interface associated with one or more smart home devices. In some embodiments, as described above, electronic device 500 displays the user interface 626 in FIG. 6G in response to receiving the input in FIG. 6E and/or the input in FIG. 6F. In some embodiments, the smart home devices are associated with a currently active user account, and/or with electronic device 500. In some embodiments, user interface 626 includes selectable options 628, such as selectable option 628-1 and selectable option 628-2. In some embodiments, the selectable options 628 are arranged and correspond to smart home devices associated with a portion of a dwelling, such as a room of a house, of the user. For example, selectable option 628-1 is associated with a living room of the user's home, and selectable option 628-2 is associated with a porch of the user's home. in some embodiments, electronic device 500 detects input directed to remote 610 and changes focus within user interface 626, without scrolling user interface 604. For example, remote 610 detects input including movement of contacts 620g across trackpad 611, requesting a change in focus within user interface 626.

From FIG. 6G to FIG. 6H, electronic device 500 moves the focus to correspond to selectable option 628-2 in response to detecting movement of contact 620g in FIG. 6G. In FIG. 6H, remote 610 detects a selection input with contact 620h on trackpad 611. In some embodiments, in response to detecting the selection, electronic device 500 displays a representation of media detected by, and/or communicated by, a smart home device corresponding to selectable option 628-2. For example, in FIG. 6I, electronic device 500 displays user interface 632 that is optionally the same or different from user interface 626, including media feed 630 in response to receiving the input illustrated in FIG. 6H. In some embodiments, media feed 630 corresponds to a real-time or nearly real-time stream of video collected by a smart home device, such as a camera sharing a wireless communication network with electronic device 500.

In some embodiments, and as shown in FIG. 6I, electronic device 500 displays visual indication 603, indicating that a respective function is being performed, or was recently performed by electronic device 500 and/or an input device such as remote 610 in communication with electronic device 500. For example, as described further with reference to method 700, visual indication 603 optionally indicates that respective circuitry is in use, such as location circuitry configured to detect location data being collected the electronic device 500. Additionally or alternatively, visual indication 603 corresponds to an indication that imaging circuitry is in use, audio circuitry is in use, and/or wireless communication circuitry is in use. In some embodiments, electronic device 500 displays additional or alternative visual indications corresponding to different respective functions of the electronic device 500 concurrently with visual indication 603. In some embodiments, visual indication 603 is displayed separately from the first visual element 608, such as within a different region of the display 504.

In FIG. 6I, remote 610 detects an input including contact 620i corresponding to a request to move the focus within the first visual element 608. In FIG. 6J, the electronic device 500 ceases display of user interface 632, and displays the focus of user input directed to icon 618. In FIG. 6J, remote 610 detects an input including contact 620j corresponding to a selection input directed to trackpad 611, selecting icon 618. In FIG. 6K, electronic device 500 displays user interface 636 in response to the selection input detected in FIG. 6J. In some embodiments, icon 618 corresponds to, and, when selected, causes electronic device 500 to display a control system user interface. For example, user interface 636 includes information and selectable options corresponding to one or more controls associated with electronic device 500, such as a plurality of playback controls 638-1, that are respectively selectable to fast forward, rewind, pause, and/or play media content, such as currently playing media content. User interface 636 additionally includes one or more selectable options, such as selectable options 638-2 corresponding to one or more wireless communication protocols supported by electronic device 500. For example, selectable option 638-2 optionally corresponds to a wireless network that electronic device 500 is currently connected to, and/or is selectable to initiate a process to connect to a wireless network. Additionally or alternatively in some embodiments, user interface 636 includes a selectable option for other wireless protocols, such as Bluetooth protocols, that is selectable to initiate pairing and/or connection with peripheral devices such as earbuds, headphones, and/or pointing devices such as styli and/or computer mice. In some embodiments, user interface 636 includes a selectable option 638-3 corresponding to a sleep timer. In some embodiments, in response to detecting a selection input while focus is directed to selectable option 638-3, electronic device 500 initiates a process to set a countdown timer, such as prompting a user to set an amount of time using a text entry field and or one or more directional controls increasing or decreasing and amount of time. In some embodiments, after setting the countdown timer, and at the expiration of the countdown timer, electronic device ceases display of any currently playing media and/or enters a low power or shutdown state. In some embodiments, user interface includes additional or alternative selectable options, respectively selectable to cause display of additional user interfaces and/or controls, as represented by selectable option 638-4.

In some embodiments, user interface element 608 is displayed at a position relative to display 504 in accordance with one or more user settings. For example, in accordance with a determination that a user setting specifying a country that the electronic device is located in corresponds to a first country, the electronic device optionally displays user interface element 608 as illustrated in the figures herein, such as at toward a right edge of display 504, and/or toward a top edge of display 504. In some embodiments, in accordance with a determination that the user setting corresponds to a second country, different from the first (e.g., a country in which text is read from right-to-left), electronic device 500 displays visual element 608 at a second position, different from the first position, such as toward a left edge and/or toward the top edge of display 504. In some embodiments, the position is configurable independent of a country setting, and in some embodiments, is displayed in proximity to a periphery of display 504.

In FIG. 6K, remote 610 detects an input including contact 620k directed to button 640. In some embodiments, in response to detecting selection of button 640, to the electronic device 500 navigates user focus away from a currently focused visual element included in user interface 604 and/or user interface element 608. In some embodiments, in accordance with the determination that media content or a respective user interface is currently displayed when button 640 is selected, electronic device 500 initiates a process to display a most recently displayed user interface, that was immediately displayed prior to the respective user interface or the media content. In some embodiments, in accordance with the determination that focus is directed to the visual element 608, and/or directed to a user interface such as user interface 636 displayed in response to detecting input directed to first visual element 608, electronic device 500 changes focus from the first visual element 608 and/or an associated user interface, to another user interface, such as user interface 604.

From FIG. 6K to FIG. 6L, in response to input 620k in FIG. 6K, electronic device 500 moves focus from visual element 608 in FIG. 6K to user interface 604 in FIG. 6L, without scrolling the user interface 604. For example, in FIG. 6L, focus is directed to a first representation 606-1 included in representation 606 corresponding to a first application. In some embodiments, electronic device 500 concurrently changes display of first visual element 608 in response to receiving the input in FIG. 6K. For example, first visual element 608 is relatively smaller in dimensions in FIG. 6L as compared to in FIG. 6K. Additionally or alternatively, first visual element 608 in FIG. 6L includes less information and/or fewer selectable options than when focus was directed to the visual element 608, relative to as shown in FIG. 6K. In some embodiments, while a respective function of electronic device 500 continues to be performed, electronic device 500 maintains display of visual indication 603, optionally independent of a focus of user input. For example, the electronic device 500 continues to display visual indication 603 in FIG. 6L in accordance with the determination that location circuitry is in use. In some embodiments, when focus changes from corresponding to the visual element 608 to user interface 604, electronic device 500 displays the focus corresponding to a default position, such as a leftmost, a rightmost, at a top, and/or at a bottom representation of representations 606. In FIG. 6L, remote 610 detects input including contact 620L requesting navigation of user interface 604. In some embodiments, in accordance with the determination that the request to navigate user interface 604 changes user focus to a position that requires scrolling of user interface 604, electronic device 500 updates a current scrolling position from an initial position to an updated position in accordance with the request. In some embodiments, the request includes a request to change user focus. In some embodiments, the request includes an express request to scroll user interface 604 to an updated scrolling position, such as a manipulation of a scrollbar (e.g., via a mouse, via a voice command, and/or via an air gesture), and/or movement of simultaneous contacts across trackpad 611.

From FIG. 6L to FIG. 6M, electronic device 500 scrolls user interface 604, moving representations 606 upwards and additionally displaying representations 642. In some embodiments, in accordance with the determination that the current scrolling position satisfies one or more criteria, including a criterion that is satisfied when the current scrolling position is outside a first range of one or more positions, electronic device 500 ceases display of visual element 608, as is the case in FIG. 6M. Thus, in some embodiments, in accordance with a determination that a scrollable user interface such as user interface 604 is currently scrolled to a position outside a defined range of positions (e.g., a first row of representations of applications, a first column of representations of applications, a first group of representations of applications), electronic device 500 forges display of the pill corresponding to user interface element 608. In some embodiments, electronic device 500 maintains display of visual indication 603, independent of whether or not the first visual element 608 is displayed. In some embodiments, representations 642 include representation 642-1, corresponding to a newly displayed, first representation of an application, representation 642-2, corresponding to a second application, and representation 642-3, corresponding to a gaming application. Thus, in some embodiments, user interface 604 includes applications directed to a plurality of different types of applications, described further with reference to method 700.

From FIG. 6M to FIG. 6N, electronic device 500 detects that location circuitry is no longer in use, and thus ceases display of the visual indication 603, without detecting an express user input dismissing the visual indication 603 in FIG. 6N. In FIG. 6N, remote 610 detects an input including contact 620n corresponding to selection of the user interface element (e.g., representation 642-1) that has the current focus. In response to detecting the input including contact 620n, electronic device 500 optionally initiates display of an application user interface corresponding to representation 642-1, such as a media playback user interface.

From FIG. 6N to FIG. 6O, electronic device 500 receives one or more inputs to initiate playback of the media, such as a selection of a representation of media included in the media playback user interface displayed in response to the input detected in FIG. 6N. In some embodiments, while displaying the media content 605, electronic device 500 displays visual indication 603 in FIG. 6O while displaying the media content, corresponding to an indication that location circuitry is in use without displaying visual element 608. In FIG. 6O, remote 610 detects an input, including contact 620o, corresponding to a request to display one or more playback controls associated with the currently displayed media.

From FIG. 6O to FIG. 6P, in response to receiving the input including contact 620o in FIG. 6O, electronic device 500 displays playback controls overlaid on media content 605. For example, controls 644 include one or more selectable options that, when selected, cause the electronic device 500 to pause, play, fast forward, rewind, and/or otherwise manipulate a current playback position of the media, such as buttons that, when selected, cause the electronic device 500 to skip forward or backward through the media content in accordance with defined intervals of time (e.g., 1, 2.5, 5, 10, 15, or 30 seconds). Additionally, electronic device 500 displays scrubber bar 646 in response to the input detected in FIG. 6O, corresponding to a timeline media content playback, and indicative of a current playback position of the media content. In some embodiments, in response to the input including contact 620o in FIG. 6O, electronic device 500 displays visual element 608 in FIG. 6P concurrently with controls 644 and scrubber bar 646. In some embodiments, visual element 608 has one or more characteristics of the first visual element described with reference to FIG. 6A (e.g., visual element 608 in FIG. 6P includes a subset of information and/or selectable icons that are able to be displayed, until an input such as input including contact 620a in FIG. 6A is detected). In some embodiments, while displaying visual element 608 and media content 605, electronic device 500 detects one or more inputs described with reference to FIGS. 6A-6K. In some embodiments, in response to detecting the one or more inputs electronic device 500 performs one or more operations described with reference to FIGS. 6A-6K, including, but not limited to: displaying focus of user input directed to visual element 608, including additional information and/or selectable options in response to directed focus to visual element 608, moving focus between selectable options included in visual element 608, and/or displaying user interfaces associated with a focused selectable option.

From FIG. 6P to FIG. 6Q, electronic device 500 detects that input has not been directed to remote 610 for a period of time greater than a threshold period of time (E. G., 0.1, 0.5, one, 1.5, two, three, 5, or 10 seconds), and in response, ceases display of the playback controls and the visual element described with reference to FIG. 6P. In FIG. 6Q, electronic device 500 detects that location circuitry is no longer in active use, and accordingly ceases display of the visual indication 603 (illustrated in FIG. 6P). In FIG. 6Q, remote 610 detects an input including contact 620q corresponding to a request to display the media playback controls.

From FIG. 6Q to FIG. 6R, electronic device 500 displays controls 644, scrubber bar 646, and visual indication 608 in response to the input including contact 620q. In FIG. 6R, the first visual element 608 includes information such as the time of day and including selectable options 614-2, and does not include a visual indication that a respective function is being performed, such as visual indication 603 illustrated in FIG. 6P.

FIG. 7 is a flow diagram illustrating a method of facilitating display of a control user interface element overlaid over respective user interfaces in accordance with some embodiments.

The method 700 is optionally performed at an electronic device such as device 100, device 300, or device 500 as described above with reference to FIGS. 1A-1B, 2-3, 4A-4B and 5A-5C. Some operations in method 700 are, optionally combined and/or order of some operations is, optionally, changed.

As described below, the method 700 provides ways to facilitate efficient control a scrollable user interface and ways access to information and/or additional users interfaces via a control user interface element. The method reduces the cognitive burden on a user when interacting with a user interface of the electronic device of the disclosure, thereby creating a more efficient human-machine interface. For battery-operated electronic devices, increasing the efficiency of the user's interaction with the user interface conserves power and increases the time between battery charges.

In some embodiments, method 700 is performed at an electronic device in communication with one or more input devices and a display generation component, such as electronic device 500 in communication with remote 610 and display generation component 504. In some embodiments, the electronic device is a device configured to provide display of media and/or one or more user interfaces, such as a digital media player. In some embodiments, the electronic device is a controller device configured to detect user input to navigate a user interface, such as a remote control in communication with a media set-top box and/or a media consumption device (e.g., a laptop, a cell phone, a tablet computer, and/or a wearable device such as a head-mounted device or a wrist-worn device). In some embodiments, the display generation component is and/or includes circuitry to present images to a user of the electronic device, such as a television, a projecting device, a touch screen, and/or a computer monitor. In some embodiments, the one or more input devices include one or more sensors in wireless and/or wired communication with the electronic device and/or the display generation component, and/or one or more devices such as a remote control, a cell phone, a tablet, a laptop, and/or a computing peripheral. In some embodiments, the display generation component and/or the one or more input devices are partially or entirely integrated into a housing of the electronic device, and in some embodiments, are at partially or entirely external to the electronic device and in communication (wirelessly and/or via a wired connection) with the electronic device.

In some embodiments, while displaying, via the display generation component, a scrollable user interface, such as user interface 604 in FIG. 6L, the electronic device detects (702a), via the one or more input devices, one or more first inputs including a request to navigate the scrollable user interface, such as movement of contact 620L in FIG. 6L. For example, the scrollable user interface includes and/or is a media browsing and consumption user interface, an application browsing user interface, a home screen user interface of the electronic device, a web browsing user interface, and/or a text-based user interface. In some embodiments, the one or more inputs include a request to re-display the scrollable user interface, a request to scroll the user interface, a request to select a representation of media content (e.g., a thumbnail, a textual description of the media content, and/or representation of an entity associated with the media content such as a provider of the media content), and/or a request to select a hyperlink presented in the scrollable user interface and/or a request to display a user interface of a respective application of the electronic device (e.g., a content consumption application or a game application). In some embodiments, before displaying the user interface, the electronic device detects one or more inputs to initiate display of the scrollable user interface, and in response to detecting such one or more inputs, the electronic device displays the scrollable user interface. In some embodiments, the electronic device displays a visual indication highlighting a current point of focus of the scrollable user interface-referred to herein as “focus”—such as a cursor, a border surrounding a currently focused element of the scrollable user interface (e.g., a button, a representation of media, and/or a control element that is selectable to display one or more user settings and/or controls associated with the electronic device and/or the scrollable user interface), and/or a visual distinguishing of the currently focused element relative to the scrollable user interface, including but not limited to the border, a changing of a color and/or saturation of the focused element, a glowing visual effect simulating a light source emanating from behind the focused element, and/or a changing of a fill pattern of the focused element. In some embodiments, in response to one or more inputs launching (e.g., displaying) the scrollable user interface, the electronic device displays a respective portion of the scrollable user interface corresponding to a last-scrolled position of the scrollable user interface, and/or a default position of the scrollable user interface.

It is understood that the one or more inputs include any manner of suitable one or more inputs, such as movement of an object contacting a surface (e.g., a finger and/or input device contacting a touch-sensitive surface and/or a non-touch surface monitored by the electronic device and/or by a device in communication with the electronic device), an air gesture detected by the electronic device (e.g., an air pinching including contacting of respective fingers of a hand of a user of the electronic device, a waving of the hand and/or finger(s) of the hand, and/or an air pointing of a finger of the user), and/or input provided via an input device such as a stylus and/or pointing device in communication with the electronic device, and/or a movement of a computer mouse in communication with the electronic device. As referred to herein, a selection input optionally refers to one or more inputs detected by the electronic device via the one or more input devices, such as a tapping of a surface (e.g., touch-sensitive or non-touch sensitive surface) like a tapping of a trackpad, an air gesture (e.g., an air pinch, air wave, and/or air point) directed toward a user interface element and/or an air gesture detected while the user's attention (e.g., gaze) is directed to the user interface element, a pressing of a button of a device in communication with the electronic device such as a mouse and/or a stylus, and/or a voice command requesting a selection of the user interface element. It is understood that the selection input optionally is directed toward a target of focus—as visually indicated by the electronic device—and/or a target of user attention.

In some embodiments, in accordance with a determination that one or more first criteria are satisfied, including a criterion satisfied when a current scrolling position relative to the scrollable user interface is within a first range of one or more positions, such as the scrolling position of user interface 604 in FIG. 6L the electronic device displays (702b), via the display generation component, a first user interface element overlaid on the scrollable user interface, wherein the first user interface element is not an element in the scrollable user interface such as user interface element 608 in FIG. 6L. In some embodiments, the electronic device displays a set of user interface elements and determines a plurality of potential positions that the user is able to navigate to within the scrollable user interface, and separate from the scrollable user interface (e.g., overlaid over the media user interface), the electronic device displays the first visual indication. As described further below, in some embodiments, the first user interface element includes information such as a current user account logged into the electronic device and/or an application included in memory at the electronic device, a time of day, and/or an indication of content sharing. In some embodiments, the first visual indication is associated with an operating system of the electronic device. For example, the first visual indication continues to be displayed in response to detecting one or more inputs ceasing display of the scrollable user interface, such as exiting a scrollable media browsing and playback user interface and/or a launching of user interface of an application, other than the scrollable user interface. As an additional example, in response to detecting one or more inputs modifying dimensions and/or visibility of the scrollable user interface, such as changing a size of a window including the scrollable user interface, launching a second user interface displayed side-by-side with the scrollable user interface, minimizing the scrollable user interface, and/or displaying another user interface overlaying the scrollable user interface, the electronic device continues to display the first user interface element at a same position relative to the image displayed by the display generation component. Thus, the first user interface element is optionally not an element in the scrollable user interface, and/or optionally persists independently of what user interface(s) are displayed.

In some embodiments, the electronic device ceases display of the first user interface element that is not included in the scrollable user interface when the scrollable user interface is scrolled outside a first range of one or more positions (e.g., scrolled to second range of one or more positions different from the first range). In some embodiments, the electronic device displays a representation the focus, and moves the focus to positions of the scrollable user interface such as positions corresponding to user interface elements of the scrollable user interface in accordance with navigation input. For example, the electronic device displays the focus directed to a user interface element of the scrollable user interface while the electronic device displays a first set of one or more user interface elements, that are displayed when the current scrolling position corresponds to a first position (e.g., buttons, representations of media, textual information, and/or one or more background images and/or videos). In response to detecting one or more navigation inputs interacting with the scrollable user interface, such as a moving of the focus vertically, laterally, and/or some combination thereof, the electronic device optionally maintains display of the first user interface element and/or the first set of one or more user interface elements in accordance with a determination that the navigation inputs do not include a request to update the current scrolling position relative to the scrollable user interface. For example, the first visual element continues to be displayed in response to detecting navigation input causing the focus to move between currently displayed user interface elements of the scrollable user interface, and not moved beyond a user interface element at a periphery of the scrollable user interface, and/or is not moved to a partially displayed user interface element at the periphery of the scrollable user interface, because such movement of focus corresponds to a request to scroll the user interface, optionally outside the first range of one or more positions. In some embodiments, in response to detecting the one or more navigation inputs, the electronic device optionally ceases display of the first user interface element in accordance with a determination that the navigation input(s) include a request to scroll the scrollable user interface beyond the first range of one or more positions. For example, the electronic device optionally detects navigation input moving the focus beyond the periphery and/or to a partially displayed user element near and/or at the periphery of the scrollable user interface, thus including a request to scroll the user interface, thereby changing the current scrolling position to an updated scrolling position. In accordance with a determination that the current scrolling position is not within the first range of one or more positions, the electronic device optionally ceases display of the first visual element, and/or optionally replaces display of the first set of one or more user interface elements with a second set of one or more user interface elements, optionally including at least a portion of the first set of one or more user interface elements. Thus, dependent upon the updated current scrolling position, the electronic device optionally maintains display or ceases display of the first user interface element.

In some embodiments, the navigation inputs include a changing of focus to an element partially displayed or not displayed prior to receiving the navigation inputs and/or a request to scroll the scrollable user interface without changing the focus. The request to update the current scrolling position, for example, optionally includes moving an indication of focus past a threshold position relative to the scrollable user interface, optionally includes a manipulation of the current scrolling position (e.g., a moving of a scroll bar that is selectable and moveable to scroll the user interface), and/or optionally includes selection of a visual representation (e.g., a series of circles indicative of displaying respective pages of the scrollable user interface) corresponding to respective sets of one or more user interface elements. For example, the scrollable user interface is optionally continuously scrollable, similar to as though the display generation component were presenting a portion of a physical page at a time, the presented portion varied in accordance with navigation input requesting modification of a current scrolling position. As an additional example, the scrollable user interface is optionally discretely scrollable, such as when one or more user interface elements are arranged in rows, columns, and/or in a loose grid, and navigation input requesting navigation of focus to an updated position beyond a currently displayed user interface elements of a currently displayed row, column, and/or grid, and/or to a currently, partially displayed user interface element (e.g., a user interface element that is only half-displayed) is optionally detected. Additionally or alternatively, the scrollable user interface is optionally arranged in one or more pages including respective sets of user interface elements, and in response to detecting movement of the focus beyond an edge of currently displayed user interface elements, the electronic device replaces display of a current page with an updated page of user interface elements.

In some embodiments, in accordance with a determination that the one or more first criteria are not satisfied, the computer system forgoes (702c) the displaying of the first user interface element in the scrollable user interface, such as user interface element 608 that is not displayed in FIG. 6M. For example, as described previously, in response to detecting one or more navigation inputs that do not include a request to update the current scrolling position, the electronic device maintains display of the first set of user interface elements and maintains display of the first user interface element. In some embodiments, the electronic device detects navigation input scrolling the scrollable user interface and maintains display of the first visual element in accordance with a determination that the updated scrolling position is not beyond the first range of the one or more positions of the scrollable user interface while concurrently updating display of user interface elements included in the scrollable user interface in accordance with the updated, current scrolling position. In some embodiments, while the electronic device is not displaying the first user interface element, the electronic device detects navigation input, and continues to not display the first user interface, such as in accordance with a determination that current scrolling position is not updated to a position within the first range of one or more positions, and/or such as in accordance with a determination that the focus is moved and does not include a request to scroll the scrollable user interface. Displaying the first user interface element in accordance with the current scrolling position of the scrollable user interface reduces the likelihood the user erroneously directs input toward the first user interface element when intending to interact with the scrollable user interface, thereby reducing erroneous user input and processing required to correct for the erroneous user input.

In some embodiments, while displaying the first user interface element, the electronic device detects, via a hardware input device included in the one or more input devices, one or more second inputs, such as input including contact 620a directed to button 613 in FIG. 6A. optionally different from the one or more first inputs; For example, the electronic device is optionally in communication with a hardware input device that the user is able to interface with to navigate user interface(s) presented by the electronic device. In some embodiments, the hardware input device is a remote-control device, including mechanical and/or electromechanical controls, such as hardware buttons, rotary dials, a keyboard, and/or switches. In some embodiments, the hardware input device includes one or more surfaces, and is configured to detect objects contacting, moving, and/or pressing on the one or more surfaces, such as one or more touch-sensitive surfaces (e.g., capacitive and/or resistive touchpads and/or touchscreens), and/or one or more non-touch sensitive surfaces that the hardware input device detects (e.g., acoustically and/or optically). In some embodiments, the hardware input device is a mobile phone, a tablet computer, a laptop, and/or a wearable device, such as a wrist-worn device and/or a head-mounted device.

In some embodiments, in response to detecting the one or more second inputs, and in accordance with a determination that the one or more second inputs include an input that satisfies one or more second criteria, the electronic device updates, via the display generation component, the first user interface element to include one or more selectable user interface elements, wherein the one or more selectable user interface elements are respectively selectable to initiate display of a respective user interface associated with the selected user interface element, such as icon 616 and icon 618 in FIG. 6B. In some embodiments, the second one or more inputs include one or more contacts (sequentially and/or concurrently detected), movement of one or more contacts, and/or a force of the one or more contacts. In some embodiments, in accordance with a determination that one or more respective inputs of the one or more second inputs satisfy one or more second criteria, the electronic device displays the first user interface element and/or modifies display of the first user interface element. In some embodiments, the second one or more criteria including a criterion that is satisfied based on characteristic(s) of the second one or more inputs. For example, the criterion optionally is satisfied when a force of a contact between an object (e.g., a finger, multiple fingers, a hand, and/or an input device such as stylus) and a surface of the hardware input device is greater than a threshold amount of force (e.g., 0.001, 0.005, 0.01, 0.05, 0.1, 0.5, 1, or 1.5N). Additionally or alternatively the second one or more criteria optionally include a criterion that is satisfied when a duration of a selection input (e.g., a pressing of a button, and/or a contact between the object and the surface of the hardware input device) is maintained for a period of time greater than a threshold period of time (e.g., 0.001, 0.005, 0.01, 0.05, 0.1, 0.5, 1, 1.5, 2.5, or 5 seconds). In some embodiments, in response to detecting a selection input that is maintained for a duration of time less than the threshold of time, the electronic device initiates a process to display a user interface that is not associated with the one or more selectable user interface elements, such as a home user interface associated with an operating system of the electronic device, and/or a user interface of a media content application. It is understood that additional or alternative criteria are applicable, such as criteria satisfied based on a number of inputs provided concurrently and/or provided in succession, and/or criteria satisfied when inputs that correspond to predetermined gestures (e.g., dragging of an object across a surface of the hardware input device) are detected.

In some embodiments, in response to the one or more second inputs that satisfy the one or more second criteria, the electronic device updates display of the first user interface element. The updating optionally includes changing a visual appearance (e.g., color, scale, dimension(s), pattern, and/or simulated backlighting effects of the first user interface element) applied to the first user interface element, and optionally includes displaying additional content within and/or surrounding the first user interface element. For example, the electronic device optionally updates the first user interface element to include one or more selectable options (e.g., selectable user interface elements). In some embodiments, the one or more selectable options are respectively selectable—in response to detecting a selection input, as described above—to initiate a process to display a user interface corresponding to the selected, selectable option. In some embodiments, the one or more selectable options are selected in response to detecting user input changing focus to correspond to a particular selectable option (e.g., a horizontal and/or vertical navigation input, such as a selection of a d-pad button, a swiping across a touch-sensitive surface, and/or a contact rotating around a click wheel). For example, a first selectable optionally corresponds to a graphical icon representative of a user account currently logged into the electronic device, and/or an application included in memory of the electronic device. In some embodiments, the first user interface is updated to include visual indications that are not selectable to display user interfaces In some embodiments, the selectable options additionally or alternatively include selectable options that are selectable to cause the electronic device to display one or more media playback controls and/or are themselves media playback controls, that are selectable to cause display of a smart home device user interface, that are selectable to cause display of a control panel user interface, associated with settings of the electronic device (e.g., display brightness controls, wireless network controls, and/or notification suppression controls), and/or that are selectable to cause display of a sleep timer user interface, associated with setting a period of time that the electronic device will continue to present respective content (e.g., media or user interfaces), after which the electronic device will cease presentation of any respective content (e.g., will shut down, enter a low power mode, and/or exit media playback mode). In some embodiments, the updated first user interface includes information that is not selectable to cause display of an associated user interface. For example, the first user interface element is optionally updated to include a current time, a representation of currently playing audio, a representation of circuitry in use and/or recently in use (e.g., global positioning circuitry, camera circuitry, and/or audio input circuitry, of the electronic device and/or of the hardware input device), a representation of a current function being performed (e.g., an indication that a video and/or cellular call is ongoing and/or an indication that content displayed by the electronic device is being shared with another electronic device) and/or an indication of currently status of the electronic device and/or the hardware input device (e.g., that the electronic device is connected to a Wi-Fi network, a Bluetooth device, and/or a battery icon indicating a current battery level of the hardware input device).

In some embodiments, in response to detecting navigation input and/or selection input, and/or in response to detecting the updating of the first user interface, the electronic device displays an indication of focus directed to a respective selectable option of the one or more selectable options. In some embodiments, before detecting the second one or more inputs satisfying the second one or more criteria, the focus is not displayed, or is displayed corresponding to a portion of another user interface (e.g., the scrollable user interface), and thereafter shifts to the respective selectable option. In some embodiments, the first user interface element is updated, and the electronic device forgoes display of the focus until a navigation input (e.g., a swiping of a touch sensitive surface, a pressing of a button, and/or a tapping of the touch sensitive surface) is detected. In response to detecting the navigation input, and while displaying the updated first user interface element, the electronic device optionally displays the focus (e.g., in accordance with the navigation input or directed to a default user interface element, such as a leftmost, rightmost, or center selectable option of the one or more selectable option). Updating the first user interface element to include selectable options that are selectable display additional user interfaces reduces the need for further user input required to navigate other portions of user interfaces to cause display of the additional user interfaces, thereby reducing processing required to perform operations associated with the further user input.

In some embodiments, the one or more selectable user interface elements include a first selectable element that is associated with a first user account that is currently logged into the electronic device, such as icon 614-1 in FIG. 6K. For example, as described above, in response to detecting a selection input and/or focus directed toward the first selectable element (optionally while focus is directed to the first selectable element), the electronic device initiates a process to display a user interface to change and/or view a currently logged in user account. In some embodiments, the first selectable element is or includes a representation of the currently logged in (e.g., first user) account, such as a graphical representation of the user corresponding to the user account, an avatar corresponding to the user, and/or one or more letters (e.g., a name or one or more initials) of the user.

In some embodiments, while displaying the one or more selectable user interface elements, the electronic device detects, via the one or more input devices, a third input, optionally different from the one or more first inputs and the one or more second inputs, selecting (or optionally directing the focus to) the first selectable element, for example, the input including contact 620a in FIG. 6A and/or the input including contact 620b in FIG. 6B For example, the selection input described above or directing the focus as described above.

In some embodiments, in response to detecting the third input, the electronic device displays, via the display generation component, a user account user interface, wherein the user account user interface includes a selectable option that, when selected, causes the electronic device to log into a second user account different from the first user account, such as user interface 624 in FIG. 6C. In some embodiments, the user account user interface is displayed concurrently with (optionally overlaid over) a background user interface (e.g., the scrollable user interface) and/or concurrently with the first user interface element. In some embodiments, the user account user interface includes a plurality of representations of available user accounts, and in response to detecting a selection input directed toward a respective representation (e.g., while focus is directed to the respective representation), the electronic device switches a currently logged in account to the selected user account (e.g., the second user account). In some embodiments, the user account user interface additionally includes a selectable option that is selectable to initiate a process to add a new user account to the pool of available user accounts. For example, in response to detecting a selection input directed to the selectable option, the electronic device optionally displays one or more prompts for information, such as identifiers and/or passwords, and in response to receiving information corresponding to credentials of a prospective user account, updates the plurality of representations of user accounts to include the newly entered user account. Displaying a user account user interface reduces user input required to manually switch between a currently logged in user account, and preserves visibility of a background user interface, thereby reducing processing required to handle such manual user input and/or summon and display a dedicated user account user interface.

In some embodiments, the one or more selectable user interface elements include a first selectable element that is associated with one or more smart home devices in communication with the electronic device such as icon 616 in FIG. 6G, For example, as described previously, the electronic device detects a selection input directed to the first selectable element.

In some embodiments, the electronic device detects, via the one or more input devices, a third input selecting the first selectable element or optionally directing the focus to the first selectable element, as described above, such as input including contact 620f in FIG. 6F.

In some embodiments, in response to detecting the third input, the electronic device displays, via the display generation component, a smart home user interface, wherein the smart home user interface includes a selectable option that, when selected, causes the electronic device to display a representation of a media feed provided by a respective smart home device of the one or more smart home devices such as user interface 626 including selectable options 628 in FIG. 6G. For example, in response to detecting the third input, the electronic device displays the smart home user interface overlaying the scrollable user interface and/or replacing the scrollable user interface. In some embodiments, the smart home user interface includes information, such as one or more rooms defined by a user of the electronic device, one or more smart home devices associated with respective rooms, one or more selectable options corresponding to the one or more smart home devices, one or more graphical indications of smart home devices, and/or a current status of the one or more smart home devices. In some embodiments, in response to detecting a selection input directed to a respective selectable option of the one or more selectable options, the electronic device initiates a process to display and/or displays a stream of media such as one or more pictures and or video such as live video and/or recently captured video, communicated from a smart home device corresponding to the selected selectable option. In some embodiments, the stream of media is displayed within the smart home user interface, and/or at another portion of the display not corresponding to the smart home user interface (e.g., overlaying the scrollable user interface). In some embodiments, in response to detecting a selection input directed toward a selectable option, the computer system changes the functionality of a corresponding smart home device, such as enabling or disabling the smart home device, turning on or turning off the smart home device, and/or presenting audio or ceasing presentation of audio provided by the smart home device. Including a selectable element within the first user interface element that is selectable to initiate a process to display media provided by a smart home device in a smart home user interface reduces user input otherwise required to cause display of the media, thereby reducing processing required to handle such user input.

In some embodiments, while a focus of user input is directed to a second user interface element included in the scrollable user interface and different from the first user interface element, such as a focus of user input optionally not displayed in FIG. 6A, the electronic device detects, via the one or more input devices, a third input, such as an input including contact 620a in FIG. 6A. For example, the focus of user input is optionally not displayed, or optionally displayed, and optionally has one or more characteristics of focus described previously.

In some embodiments, in response to detecting the third input in accordance with a determination that the third input has a first characteristic, such as a characteristics of the contact 620a in FIG. 6A, the electronic device displays the first user interface element including the one or more selectable user interface elements, such as user interface element 608 in FIG. 6B. For example, the electronic device optionally detects that the third input has one or more characteristics, including the first characteristic. The first characteristic optionally corresponds to a type of input of the third input, such as type of input received by a respective button of a hardware input device, a type of input directed to a touch-sensitive surface, a type of input corresponding to a voice command, and/or a type of input directed to rotational sensing circuitry. In some embodiments, the first characteristic differentiates the third input from another type of input. For example, the third input is a button pressing-type input, and another input is a touch-sensitive surface-type input (e.g., a scrolling gesture of an object contacting and moving across the surface). In response to detecting the third input, the electronic device optionally updates display of the first user interface element (e.g., as described above), and in response to detecting the other input and before the third input is detected, the electronic device optionally performs one or more operations, such as navigating the scrollable user interface, and optionally forgoes updating display of the first user interface element (e.g., forgoes displaying the one or more selectable user interface elements). In some embodiments, the first characteristic is a duration of maintaining of the third input (e.g., maintaining pressing of a button, maintaining contact between an object and a surface, and/or maintaining an air pose (e.g., an arrangement of portion(s) of the user's body such as one or more fingers, hands, arms, and/or head). In some embodiments, the first characteristic is a force of the input (e.g., a force of an object contacting a surface). In some embodiments, in accordance with a determination that the third input does not include a request to navigate the scrollable user interface and/or the first user interface element, the computer system forgoes scrolling of the scrollable user interface.

In some embodiments, in accordance with a determination that the third input does not have the first characteristic, the electronic device forgoes the displaying the first user interface element including the one or more selectable user interface elements (and optionally selecting the second user interface element), such as forgoing display of user interface element 608 in FIG. 6B. For example, as described above, the electronic device optionally forgoes displaying the first user interface element and/or changing the dimensions and/or scale of the first user interface element in response to third input lacking the first characteristic. For example, the third input is an input that changes the input focus, such as directing the input focus to a third user interface element different from the first user interface element and different from the second user interface element. As another example, the third input is an input that scrolls the scrollable user interface. In some embodiments, in response to receiving a scrolling input or an input for changing the input focus, the electronic device navigates the scrollable user interface accordingly (e.g., by scrolling and/or by updating the input focus), but does not display the first user interface element. In some embodiments, in response to an input that is not for navigating the scrollable user interface, the electronic device displays the first user interface element. Displaying the first user interface element in response to a third input having a first characteristic reduces the likelihood that the user inadvertently requests display of the one or more selectable user interface elements, thus reducing user input required to dismiss and cease display of the one or more selectable user interface elements.

In some embodiments, while displaying the first user interface element including the one or more selectable user interface elements, the electronic device detects, via the one or more input devices, a fourth input, such as input including contact 620k directed to button 640 in FIG. 6K while user interface element 608 is displayed in FIG. 6K.

In some embodiments, in response to detecting the fourth input, in accordance with a determination that the fourth input satisfies one or more second criteria, including a criterion that is satisfied when the fourth input includes a request to change a focus of user input, displaying an indication of the focus of the user input in accordance with the fourth input, such as focus directed to first representation 606-1 in FIG. 6L. For example, the request to change the focus of the user input optionally includes input having one or more characteristics described above with reference to the third input that is different from the first characteristic of the third input. For example, the fourth input includes one or more swipes of an object on and/or across a touch sensitive surface included in a hardware control input device, such as a remote. In some embodiments, in response to the fourth input, the electronic device displays and/or moves a position of focus to an element is included in the first user interface element or an element included in a user interface displayed in response to receiving an input selecting one of the elements of the first user interface element. For example, the electronic device detects a series of swipes of the object across the touch-sensitive surface, and in response, optionally moves the indication of focus to an updated position corresponding to the respective user interface element based on the number and/or magnitude of movement of the swipes. In some embodiments, in response to detecting the fourth input while the focus of user input is directed to the scrollable user interface and/or the first user interface element does not include the one or more selectable user interface elements, the electronic device optionally navigates the scrollable user interface (e.g., to a respective user interface element included in the first user interface element, as described further below). For example, navigation optionally includes displaying an indication of the focus in the scrollable user interface, moving the indication of focus, and in accordance with a determination that the movement of the focus corresponds to a request to update the current scrolling position beyond the range of first one or more positions (described previously), scrolls the scrollable user interface to include additional content, and/or to not include content not corresponding to the current scrolling position. In some embodiments, in response to detecting the fourth input, and the computer system forgoes scrolling the scrolling user interface in accordance with a determination that the fourth input does not include a navigational input.

In some embodiments, the second one or more second criteria include a criterion satisfied when the fourth input does not have a second characteristic, optionally different (or the same) as the first characteristic of the third input. For example, in accordance with a determination that the fourth input is not a pressing of a first button (optionally a same button that is pressed to cause display of the one or more selectable user interface elements), and/or includes a swiping across a touchpad and/or a selection of a directional button on a directional pad (d-pad), the electronic device optionally moves the focus to the respective user interface element.

In some embodiments, in accordance with a determination that the fourth input satisfies one or more third criteria optionally different from the one or more second criteria, the electronic device ceases display of the one or more selectable user interface elements, such as ceasing display of icons 616 and 618 illustrated in FIG. 6K. For example, in accordance with a determination that the fourth input corresponds to a pressing of the first button (e.g., the button that caused display of the first user interface element) and/or a second button (e.g., a “back” button to move focus of user input away from the first user interface element) the electronic device ceases display of the one or more selectable user interface elements and/or reverts the visual appearance of the first user interface element to its visual appearance before the second one or more inputs were detected, such as decreasing the size and/or dimensions of the first user interface element to its size before the second one or more were detected. Changing focus between the one or more selectable user interface elements and/or ceasing display of the one or more selectable user interface elements in accordance with a determination that fourth input satisfy one or more second or one or more third criteria, respectively, reduces the likelihood that subsequent user input is directed away or toward from the first user interface erroneously, thereby reducing processing required to handle the user input.

In some embodiments, while the first user interface element is not displayed, the electronic device detects, via a hardware input device included in the one or more input devices, such as remote 610 in FIG. 6A, one or more second inputs, including a request to display the first user interface element, such as input including contact 620a in FIG. 6A. For example, the one or more second inputs optionally include an input directed to a hardware control device, such as selection of a button of a remote device in communication with the electronic device. In some embodiments, in accordance with a determination that one or more second inputs include input that has one or more characteristics that satisfy one or more respective criteria (e.g., a duration of pressing of the button maintained for a period of time greater than a threshold amount of time (e.g., 0.05, 0.1, 0.5, 1, 1.5, 2, or 3 seconds), a force of pressing the button greater than a threshold amount of force (e.g., 0.05, 0.1, 0.5, 1, 1.5, 2, or 3N), a duration of a contact on a trackpad of the remote device maintained for a period of time greater than a threshold amount of time (e.g., 0.05, 0.1, 0.5, 1, 1.5, 2, or 3 seconds), and/or a force of the contact on the trackpad of the remote device greater than a threshold amount of force (e.g., 0.05, 0.1, 0.5, 1, 1.5, 2, or 3N)), the electronic device determines that the input corresponds to the request to display the first user interface element. In some embodiments, the second one or more inputs are detected while the scrollable user interface is displayed (e.g., and while the current scrolling position is outside of the range of first one or more scrolling positions relative to the scrollable user interface), while another user interface is additionally or alternatively displayed (e.g., a content user interface such as a text-based or media-based content user interface other than the scrollable user interface), and/or while media content is being displayed and/or while a media playback user interface presenting the media content is displayed. In some embodiments, in accordance with a determination that the one or more second inputs do not include a request to navigate the scrollable user interface and/or the first user interface element, the computer system forgoes scrolling of the scrollable user interface.

In some embodiments, in response to detecting the one or more second inputs, the electronic device displays, via the display generation component, the first user interface element (optionally while maintaining the current scrolling position relative to the scrollable user interface or changing the scrolling position relative to the scrollable user interface), such as the display of user interface element 608 in FIG. 6B. In some embodiments, when the second one or more inputs are detected while displaying another user interface other than the scrollable user interface and/or media content, the electronic device displays the first user interface overlaid over the other scrollable user interface and/or media content optionally without updating portions of the other user interface visible while displaying the first user interface element. In some embodiments, the position and/or information included in the first user interface when displayed overlaid over the scrollable user interface is the same or is different than displayed overlaid over another user interface and/or media content. Displaying the first user interface element in response to detecting and/or detecting an indication of inputs that are detected at a hardware input device provides flexibility in invoking the first user interface element, thus improving efficiency of interaction with the electronic device.

In some embodiments, displaying the first user interface element includes, in accordance with a determination that one or more second criteria different from the one or more first criteria are satisfied (e.g., the device is performing a respective function, such as operating a camera and/or microphone and/or collecting location data, as described in more detail below), the electronic device displays a first set of user interface elements and a first visual element (e.g., concurrently) corresponding to a function of the electronic device, such as the visual indication 603 in FIG. 6K. For example, the electronic device optionally indicates a function that is being performed and/or recently has been performed by the electronic device and/or a hardware control device in communication with the electronic device. The function optionally indicates circuitry that is and/or recently was in use, such as a microphone that is/has collected audio information, geolocation circuitry detecting a location of the electronic device and/or the hardware control device, optical circuitry such as cameras and/or depth sensors collecting imaging data, and/or communication circuitry sharing content with another electronic device and/or communicating with a computer system (e.g., servers). In some embodiments, the function corresponds to a user setting, such as a notification suppression mode that is currently engaged, forgoing display of notifications that would otherwise be presented via the electronic device, and/or an alarm that is currently set. In some embodiments, the first visual element includes an icon, a shape, and/or a color corresponding to the function(s) that are being performed. In some embodiments, the first visual element is displayed with additional visual elements to indicate concurrent and/or recently concurrent functions that are and/or have been performed.

In some embodiments, while displaying a respective user interface other than the scrollable user interface, via the display generation component, such as while displaying media content 605 in FIG. 6O, in accordance with a determination that the one or more second criteria are satisfied, the electronic device displays, via the display generation component, the first visual element without displaying the first user interface element and without displaying the first set of user interface elements, such as the display of visual indication 603 in FIG. 6O. For example, while the scrollable user interface is not displayed (e.g., while another user interface is alternatively displayed (e.g., a content user interface such as a text-based or media-based content user interface other than the scrollable user interface), while media content is being displayed, and/or while a media playback user interface presenting the media content is displayed), the electronic device displays the first visual element and forgoes display of the first user interface element and/or the first set of user interface elements. In some embodiments, the first visual element is displayed (e.g., without displaying the first user interface element and/or without displaying the first set of user interface element) while the current scrolling position relative to the scrollable user interface does not satisfy the one or more first criteria. In some embodiments, the first visual element is displayed without detecting an express user input requesting display of the first visual element (e.g., automatically, when the one or more second criteria are satisfied), and/or continues to be displayed while the one or more second criteria are satisfied. In some embodiments, the electronic device ceases display of the first visual element in accordance with a determination that one or more third criteria are satisfied, such as a criterion satisfied when the electronic device is displaying media content in a full screen mode (e.g., occupying the entirety of a display). In some embodiments, in accordance with a determination that a respective scrollable user interface, different from the scrollable user interface, is displayed and in accordance with the determination that he one or more second criteria are satisfied, the electronic device displays the first visual element without displaying the first user interface element and without displaying the first set of user interface element. Displaying the first visual indication independently of display of the first user interface element provides consistent visual feedback about a state of operations of the electronic device, thus reducing the need for manual assessments of the state and reducing processing required to detect input and perform operations related to such assessments.

In some embodiments, the one or more second criteria include a criterion that is satisfied when a respective input device of the one or more input devices is being used, such as a function associated with remote 610 in FIG. 6O. For example, the first visual element optionally is a shape of a color (e.g., orange, green, yellow, or red) that indicates that location circuitry, optical circuitry, and/or communication circuitry of the electronic device and/or another device in communication with the electronic device (e.g., the respective input device corresponding to a hardware input device such as a remote, a mobile phone, and/or a tablet) are currently in use and/or were recently in use. For example, when an application stored in memory of the electronic device is accessing location data provided by the electronic device and/or the hardware input device, the electronic device optionally displays the first visual element with a first color. When another application stored in memory is accessing imaging data detected by the electronic device and/or the hardware input device, the electronic device optionally displays the firs visual element with a second color, different from the first. In some embodiments, the first visual indication is displayed with a different form (e.g., shape, graphic, and/or some combination thereof) based on what respective circuitry is and/or has been used. In some embodiments, in accordance with a determination that the circuitry is no longer in use, the electronic device ceases display of the circuitry. In some embodiments, the respective input device corresponds to an input device used to share currently displayed content to another electronic device, other than the input device. For example, the electronic device optionally communicates data and/or an indication of data corresponding to what is displayed via the display generation component (e.g., the scrollable user interface, the first user interface element, focus, and/or media content). Displaying the first visual indication in accordance with a determination that a respective input device is in use provides visual feedback about functions of the input device that are ongoing, thus improving user awareness of communication of information provided by the respective input devices, and providing an opportunity for the user to limit collection and communication of such information, thus reducing information received and processed by the electronic device, and thereby limiting power consumption of the electronic device.

In some embodiments, the function of the electronic device includes sensing, via the one or more input devices, respective data, such as location data associated with display of visual indication 603 in FIG. 6O. In some embodiments, the function of the electronic device corresponds to data that is being detected and/or information that is being provided by an input device, such as data and/or information provided by a hardware input device described previously. The respective data optionally corresponds to location data, imaging data, audio data, and/or other personal data potentially sensitive and private to the user. It is understood that data collection and usage practices prioritize user privacy and security, as described further below. Displaying the first visual indication in accordance with a determination that a respective input device is in use provides visual feedback about functions of the input device that are ongoing, thus improving user awareness of communication of information provided by the respective input devices, and providing an opportunity for the user to limit collection and communication of such information, thus improving user privacy and reducing information received and processed by the electronic device, and thereby limiting power consumption of the electronic device.

In some embodiments, the electronic device displays, via the display generation component, a content item, for example, media content 605 in FIG. 6O. For example, the content item corresponds to and/or includes video (e.g., live video, streaming video, and/or previously stored video), graphics, photos, and/or video gaming content. In some embodiments, while displaying the scrollable user interface, the electronic device displays a selection input while focus is directed to a respective element of the scrollable user interface. In response to detecting the input, the electronic device initiates a process to display the content item, such as displaying a user interface including one or more selectable elements that are respectively selectable to cause display of the content item.

In some embodiments, while displaying the content item in accordance with a determination that one or more third criteria are satisfied (optionally different from the one or more first criteria and different from the one or more second criteria), the electronic device concurrently displays a scrubber bar associated with the content item and the user interface element including the first set of user interface elements and the first visual element with the content item, such as scrubber bar 646 and user interface element 608 in FIG. 6P. For example, the electronic device displays the content item in a full screen mode, occupying the entirety, or nearly entirety of the display area presented via the display generation component. In some embodiments, the one or more third criteria are the criteria for displaying the scrubber bar. For example, the one or more third criteria include a criterion that is satisfied in response to receiving an input, such as a tapping on a touch-sensitive surface while the content item is playing and within a threshold time (e.g., 0.5, 1, 2, 3, 4, 5, 10, or 15 seconds) of receiving the input. As another example, the one or more third criteria include a criterion that is satisfied when the content is paused. As another example, the one or more third criteria include a criterion that is satisfied when the content is paused and it has been less than the threshold time since the electronic device received the input to pause the content. In some embodiments, while the electronic device displays a scrubber bar, the electronic device concurrently provides one or more content navigation controls (e.g., respectively selectable to pause, play, rewind, fast-forward, and/or skip ahead or behind by an interval of time). In some embodiments, in response to the input, the electronic device concurrently displays the scrubber bar with the first user interface element that includes the first set of user interface elements (described previously) and the first visual element in accordance with a determination that the one or more third criteria are satisfied. In some embodiments, in accordance with a determination that the one or more third criteria are not satisfied, the electronic device concurrently displays the first visual element with the content item without displaying the scrubber bar associated with the content item, without displaying the user interface element, and without displaying the first set of user interface elements, such as visual indication 603 displayed concurrently with media content 605 in FIG. 6O. In some embodiments, while not displaying the scrubber bar, and thus in accordance with a determination that the one or more third criteria are not satisfied, the electronic device proceeds to display the first visual element, indicating a function of the electronic device that is and/or was recently performed, and forgoes display of the scrubber bar, the user interface element, and/or of the first set of user interface elements associated with the user interface element. Displaying first visual element while not displaying the scrubber bar reduces visual occlusion of the content item, thus reducing the likelihood that the user provides input erroneously interacting with the obscured content item and thereby processing required to detect and perform operations in response to the erroneous input.

In some embodiments, displaying the first user interface element in accordance with the determination that the one or more first criteria are satisfied includes, in accordance with a determination that one or more second criteria are satisfied, displaying a first set of user interface elements and a first visual element corresponding to a function of the electronic device, such as the visual element 608 including icon 616 and icon 618 in FIG. 6K, concurrently displayed with visual indication 603 in FIG. 6K. For example, while the one or more first criteria are satisfied, in accordance with a determination that one or more second criteria are satisfied, including a criterion that is satisfied when a respective function is being and/or was recently performed by the electronic device (e.g., as described with reference to the first visual element corresponding to the function of the electronic device), the electronic device displays the first user interface element optionally including the first visual element.

In some embodiments, displaying the first user interface element in accordance with a determination that the one or more first criteria are satisfied includes, while displaying the scrollable user interface such as user interface 604m and in accordance with the determination that the one or more first criteria are not satisfied, in accordance with a determination that the one or more second criteria are satisfied, such as a criterion satisfied when the current scrolling position of the user interface 604 in FIG. 6M is within a second range of positions, displaying, via the display generation component, the first visual element without displaying the first user interface element and without displaying the first set of user interface elements, such as displaying visual indication 603 in FIG. 6M without displaying user interface element 608 in FIG. 6L. For example, in accordance with a determination that the current scrolling position relative to the scrollable user interface is within a second range of positions, outside of the first range of positions described previously, the electronic device optionally displays the first visual element, and optionally forgoes display of the first user interface element and/or the first set of user interface elements, as described previously. Displaying first visual element while not displaying the first user interface element provides constant visual feedback concerning ongoing functions associated with the electronic device, thus guiding the user to cease performance of undesired functions and thereby reducing processing required to perform the undesired functions.

In some embodiments, the one or more second criteria include a criterion that is satisfied when a respective input device of the one or more input devices is being used, such as remote 610 and/or an input device included in remote 610 in FIG. 6L. For example, as described previously. Displaying the first visual indication in accordance with a determination that a respective input device is in use provides visual feedback about functions of the input device that are ongoing, thus improving user awareness of communication of information provided by the respective input devices, and providing an opportunity for the user to limit collection and communication of such information, thus reducing information received and processed by the electronic device, and thereby limiting power consumption of the electronic device.

In some embodiments, the function of the electronic device includes sensing, via the one or more input devices, respective data, such as data corresponding to data detected by remote 610 in FIG. 6L. For example, as described previously. Displaying the first visual indication in accordance with a determination that a respective input device is in use provides visual feedback about functions of the input device that are ongoing, thus improving user awareness of communication of information provided by the respective input devices, and providing an opportunity for the user to limit collection and communication of such information, thus improving user privacy and reducing information received and processed by the electronic device, and thereby limiting power consumption of the electronic device.

It should be understood that the particular order in which the operations in method 700 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 7 are, optionally, implemented by components depicted in FIGS. 1A-1B. For example, detecting operation 702a, displaying operation 702b and forgoing operation 702 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology potentially involves the gathering and use of data available from specific and legitimate sources to display user interfaces and/or information associated with devices in communication with an electronic device. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information, usage history, handwriting styles, images collected by devices etc.

The present disclosure recognizes that the use of such personal information data in the present technology can be used to the benefit of users. For example, the personal information data can be used to automatically perform operations with respect to suggesting representations of applications to incorporate into to a scrollable user interface. Accordingly, use of such personal information data enables users to enter fewer inputs to perform an action with respect to displaying and interacting with content. Further, other uses for personal information data that benefit the user are also contemplated by the present disclosure. For instance, user preferences may be used to identify smart home devices associated with the electronic device.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the user is able to configure one or more electronic devices to change the discovery or privacy settings of the electronic device. For example, the user can select a setting that only allows an electronic device to access certain devices when detecting smart home devices associated with the electronic device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content items for consumption can be suggested based on aggregated non-personal information data or a bare minimum amount of personal information, such as the user preferences being handled only on the user's device or other non-personal information.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with one or more input devices and a display generation component:
while displaying, via the display generation component, a scrollable user interface, detecting, via the one or more input devices, one or more first inputs including a request to navigate the scrollable user interface;
in accordance with a determination that one or more first criteria are satisfied, including a criterion satisfied when a current scrolling position relative to the scrollable user interface is within a first range of one or more positions, displaying, via the display generation component, a first user interface element overlaid on the scrollable user interface, wherein the first user interface element is not an element in the scrollable user interface; and
in accordance with a determination that the one or more first criteria are not satisfied, forgoing the displaying of the first user interface element in the scrollable user interface.

2. The method of claim 1, further comprising:
while displaying the first user interface element, detecting, via a hardware input device included in the one or more input devices, one or more second inputs; and
in response to detecting the one or more second inputs, and in accordance with a determination that the one or more second inputs include an input that satisfies one or more second criteria, updating, via the display generation component, the first user interface element to include one or more selectable user interface elements, wherein the one or more selectable user interface elements are respectively selectable to initiate display of a respective user interface associated with the selected user interface element.

3. The method of claim 2, wherein the one or more selectable user interface elements include a first selectable element that is associated with a first user account that is currently logged into the electronic device, the method further comprising:
while displaying the one or more selectable user interface elements, detecting, via the one or more input devices, a third input selecting the first selectable element; and
in response to detecting the third input, displaying, via the display generation component, a user account user interface, wherein the user account user interface includes a selectable option that, when selected, causes the electronic device to log into a second user account different from the first user account.

4. The method of claim 2, wherein the one or more selectable user interface elements include a first selectable element that is associated with one or more smart home devices in communication with the electronic device, the method further comprising:
detecting, via the one or more input devices, a third input selecting the first selectable element; and
in response to detecting the third input, displaying, via the display generation component, a smart home user interface, wherein the smart home user interface includes a selectable option that, when selected, causes the electronic device to display a representation of a media feed provided by a respective smart home device of the one or more smart home devices.

5. The method of claim 2, further comprising:
while a focus of user input is directed to a second user interface element included in the scrollable user interface and different from the first user interface element, detecting, via the one or more input devices, a third input; and
in response to detecting the third input:
in accordance with a determination that the third input has a first characteristic, displaying the first user interface element including the one or more selectable user interface elements; and
in accordance with a determination that the third input does not have the first characteristic, forgoing the displaying the first user interface element including the one or more selectable user interface elements.

6. The method of claim 5, further comprising:
while displaying the first user interface element including the one or more selectable user interface elements, detecting, via the one or more input devices, a fourth input; and
in response to detecting the fourth input:
in accordance with a determination that the fourth input satisfies one or more second criteria, including a criterion that is satisfied when the fourth input includes a request to change a focus of user input, displaying an indication of the focus of the user input in accordance with the fourth input; and
in accordance with a determination that the fourth input satisfies one or more third criteria, ceasing display of the one or more selectable user interface elements.

7. The method of claim 1, further comprising:
while the first user interface element is not displayed, detecting, via a hardware input device included in the one or more input devices, one or more second inputs, including a request to display the first user interface element; and
in response to detecting the one or more second inputs, displaying, via the display generation component, the first user interface element.

8. The method of claim 1, wherein displaying the first user interface element includes, in accordance with a determination that one or more second criteria different from the one or more first criteria are satisfied, displaying a first set of user interface elements and a first visual element corresponding to a function of the electronic device, the method further comprising:
while displaying a respective user interface other than the scrollable user interface, via the display generation component, in accordance with a determination that the one or more second criteria are satisfied, displaying, via the display generation component, the first visual element without displaying the first user interface element and without displaying the first set of user interface elements.

9. The method of claim 8, wherein the one or more second criteria including a criterion that is satisfied when a respective input device of the one or more input devices is being used.

10. The method of claim 8, wherein the function of the electronic device includes sensing, via the one or more input devices, respective data.

11. The method of claim 8, further comprising:
displaying, via the display generation component, a content item; and
while displaying the content item:
in accordance with a determination that one or more third criteria are satisfied, concurrently displaying a scrubber bar associated with the content item and the user interface element including the first set of user interface elements and the first visual element with the content item; and
in accordance with a determination that the one or more third criteria are not satisfied, concurrently displaying the first visual element with the content item without displaying the scrubber bar associated with the content item, without displaying the user interface element, and without displaying the first set of user interface elements.

12. The method of claim 1, wherein displaying the first user interface element in accordance with the determination that the one or more first criteria are satisfied includes in accordance with a determination that one or more second criteria are satisfied, displaying a first set of user interface elements and a first visual element corresponding to a function of the electronic device, the method further comprising:
while displaying the scrollable user interface and in accordance with the determination that the one or more first criteria are not satisfied, in accordance with a determination that the one or more second criteria are satisfied, displaying, via the display generation component, the first visual element without displaying the first user interface element and without displaying the first set of user interface elements.

13. The method of claim 12, wherein the one or more second criteria including a criterion that is satisfied when a respective input device of the one or more input devices is being used.

14. The method of claim 12, wherein the function of the electronic device includes sensing, via the one or more input devices, respective data.

15. An electronic device in communication with one or more input devices and a display generation component, the electronic device comprising:
one or more processors;
memory storing one or more programs, wherein the one or more programs are configured to be executed by the one or more processors, the one or more programs including instructions for:
while displaying, via the display generation component, a scrollable user interface, detecting, via the one or more input devices, one or more first inputs including a request to navigate the scrollable user interface;
in accordance with a determination that one or more first criteria are satisfied, including a criterion satisfied when a current scrolling position relative to the scrollable user interface is within a first range of one or more positions, displaying, via the display generation component, a first user interface element overlaid on the scrollable user interface, wherein the first user interface element is not an element in the scrollable user interface; and
in accordance with a determination that the one or more first criteria are not satisfied, forgoing the displaying of the first user interface element in the scrollable user interface.

16. A non-transitory computer readable storage medium storing one or more programs, the one or more programs comprising instructions, which when executed by one or more processors of an electronic device in communication with one or more input devices and a display generation component cause the electronic device to perform a method comprising:
while displaying, via the display generation component, a scrollable user interface, detecting, via the one or more input devices, one or more first inputs including a request to navigate the scrollable user interface;
in accordance with a determination that one or more first criteria are satisfied, including a criterion satisfied when a current scrolling position relative to the scrollable user interface is within a first range of one or more positions, displaying, via the display generation component, a first user interface element overlaid on the scrollable user interface, wherein the first user interface element is not an element in the scrollable user interface; and
in accordance with a determination that the one or more first criteria are not satisfied, forgoing the displaying of the first user interface element in the scrollable user interface.

17-22. (canceled)
